(19) United States
(12) Patent Application Publication
(10) Pub. No.: US 2003/0220860 A1
(43) Pub. Date: Nov. 27, 2003

(54) Knowledge discovery through an analytic learning cycle

(75) Inventors: Michael L. Heytens, Austin, TX (US); Steven R. Carr, San Jose, CA (US); Gregory S. Battas, Indianapolis, IN (US); Philip R. Bosinoff, Ashland, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company,L.P., Houston, TX (US)

(21) Appl. No.: 10/423,678

(22) Filed: Apr. 24, 2003

Related U.S. Application Data
(60) Provisional application No. 60/383,367, filed on May 24, 2002.

(51) Int. Cl. G06F 17/00; G06N 5/02; G06F 17/60; G06F 15/18; G06F 17/30; G06F 7/00

(52) U.S. Cl. 705/35; 706/12; 707/3; 706/47; 705/7

(57) ABSTRACT

Knowledge discovery through analytic learning cycles is founded on a coherent, real-time view of data from across an enterprise, the data having been captured and aggregated and is available in real-time at a central repository. Knowledge discovery is an iterative process where each cycle of analytic learning employs data mining. Thus, an analytic learning cycle includes defining a problem, exploring the data at the central repository in relation to the problem, preparing a modeling data set from the explored data, building a model from the modeling data set, assessing the model, deploying the model back to the central repository, and applying the model to a set of inputs associated with the problem. Application of the model produces results and, in turn, creates historic data that is saved at the central repository. Subsequent iterations of the analytic learning cycle use the historic data, as well as current data accumulated in the central repository, thereby creating up-to-date knowledge for evaluating and refreshing the model.

### REFERENCE TO PRIOR APPLICATION

This application claims the benefit of and incorporates by reference U.S. Provisional Application No. 60/383,367, titled “ZERO LATENCY ENTERPRISE (ZLE) ANALYTIC LEARNING CYCLE,” filed May 24, 2002.

### CROSS REFERENCE TO RELATED APPLICATIONS

This application is related to and incorporates by reference U.S. patent application Ser. No. 09/948,928, filed Sep. 7, 2001, entitled “Enabling a Zero Latency Enterprise”, U.S. patent Ser. No. 09/948,927, filed Sep. 7, 2001, entitled “Architecture, Method and System for Reducing Latency of Business Operations of an Enterprise”, and U.S. patent application Ser. No. ______ (Attorney docket No. 200300827-1), filed Mar. 27, 2003, entitled “Interaction Manager.

### BACKGROUND OF THE INVENTION

One challenge for the information technology (IT) of any large organization (hereafter generally referred to as “enterprise”) is maintaining a comprehensive view of its operations and information. A problem related to this challenge is how to use all events and all relevant data from across the enterprise, preferably in real time. For example, in dealing with an enterprise, customers expect to receive current and complete information around-the-clock, and want their interactions with the enterprise to be personalized, irrespective of whether such interactions are conducted face-to-face, over the phone or via the Internet. In view of such need, information technology (IT) infrastructures are often configured to address, in varying degrees, the distribution of valuable information across the enterprise to its groups of information consumers, including remote employees, business partners, customers and more.

However, with substantial amounts of information located on disparate systems and platforms, information is not necessarily present in the desired form and place. Moreover, the distinctive features of business applications that are tailored to suit the requirements of a particular domain complicate the integration of applications. In addition, new and legacy software applications are often incompatible and their capacity to efficiently share information with each other is deficient.

Conventional IT configurations include for example some form of the enterprise application integration (EAI) platform to integrate and exchange information between their Heytens et al. existing (legacy) applications and new best-of-the-breed applications. Unfortunately, EAI facilities, are not designed to support high-volume enterprise-wide data retrieval and 24-hours-aday-7-days-a-week, high-event-volume operations (e.g., thousands of events per second in retail point-of-sale (POS) and e-store click-stream applications).

Importantly also, EAI and operational data store (ODS) technologies are distinct and are traditionally applied in isolation to provide application or data integration, respectively. While an ODS is more operationally focused than, say, a data warehouse, the data in an ODS is usually not detailed enough to provide actual operational support for many enterprise applications. Separately, the ODS provides only data integration and does not address the application integration issue. And, once written to the ODS, data is typically not updateable. For data mining, all this means less effective gathering of information for modeling and analysis.

Deficiencies in integration and data sharing are indeed a difficult problem associated with IT environments for any enterprise. When requiring information for a particular transaction flow that involves several distinct applications, the inability of organizations to operate as oneorgan, rather than separate parts creates a challenge in information exchange and results in economic inefficiencies.

Consider for example applications designed for customer relationship management (CRM) in the e-business environment, also referred to as eCRMs. Traditional eCRMs are built on top of proprietary databases that do not contain the detailed up-to-date data on customer interactions. These proprietary databases are not designed for large data volumes or high rate of data updates. As a consequence, these solutions are limited in their ability to enrich data presented to customers. Such solutions are incapable of providing offers or promotions that feed on real-time events, including offers and promotions personalized to the customers.

In the context of CRMs, and indeed any enterprise application including applications involving data mining, existing solutions do not provide a way, let alone a graceful way, for gaining a comprehensive, real-time view of events and their related information. Stated another way, existing solutions do not effectively leverage knowledge relevant to all events from across the enterprise.

### BRIEF SUMMARY OF THE INVENTION

In representative embodiments, the analytical learning cycle techniques presented herein are implemented in the context of a unique zero latency enterprise (ZLE) environment. As will become apparent, an operational data store (ODS) is central to all real-time data operations in the ZLE environment, including data mining. In this context, data mining is further augmented with the use of advanced analytical techniques to establish, in real-time, patterns in data gathered from across the enterprise in the ODS. Models generated by data mining techniques for use in establishing these patterns are themselves stored in the ODS. Thus, knowledge captured in the ODS is a product of analytical techniques applied to real-time data that is gathered in the ODS from across the enterprise and is used in conjunction with the models in the ODS. This knowledge is used to direct substantially real-time responses to “information consumers,” as well as for future analysis, including refreshed or reformulated models. Again and again, the analytical techniques are cycled through the responses, as well as any subsequent data relevant to such responses, in order to create up-to-date knowledge for future responses and for learning about the efficacy of the models. This knowledge is also subsequently used to refresh or reformulate such models.

To recap, analytical learning cycle techniques are provided in accordance with the purpose of the invention as embodied and broadly described herein. Notably, knowledge discovery through analytic learning cycles is founded on a coherent, real-time view of data from across an enterprise, the data having been captured and aggregated and is available in real-time at the ODS (the central repository). And, as mentioned, knowledge discovery is an iterative process where each cycle of analytic learning employs data mining.

Thus, in one embodiment, an analytic learning cycle includes defining a problem, exploring the data at the central repository in relation to the problem, preparing a modeling data set from the explored data, building a model from the modeling data set, assessing the model, deploying the model back to the central repository, and applying the model to a set of inputs associated with the problem. Application of the model produces results and, in turn, creates historic data that is saved at the central repository. Subsequent iterations of the analytic learning cycle use the historic as well as current data accumulated in the central repository, thereby creating up-to-date knowledge for evaluating and refreshing the model.

In another embodiment, the present approach for knowledge discovery is implemented in a computer readable medium. Such medium embodies a program with program code for causing a computer to perform the aforementioned steps for knowledge discovery through analytic learning cycles.

Typically, a system for knowledge discovery through analytic learning cycles is designed to handle real-time data associated with events occurring at one or more sites throughout an enterprise. Such system invariably includes some form of the central repository (e.g., the ODS) at which the real-time data is aggregated from across the enterprise and is available in real-time. The system provides a platform for running enterprise applications and further provides enterprise application interface which is configured for integrating the applications and real-time data and is backed by the central repository so as to provide a coherent, real-time view of enterprise operations and data. The system also includes some form of data mart or data mining server which is configured to participate in the analytic learning cycle by building one or more models from the real-time data in the central repository, wherein the central repository is designed to keep such models. In addition, the system is designed with a hub that provides core services such as some form of a scoring engine. The scoring engine is configured to obtain a model from the central repository and apply the model to a set of inputs from among the real-time data in order to produce results. In one implementation of such system, the scoring engine has a companion calculation engine.

The central repository is configured for containing the results along with historic and current real-time data for use in subsequent analytic learning cycles. Moreover, the central repository contains one or more data sets prepared to suit a problem and a set of inputs from among the real-time data to which a respective model is applied. The problem is defined to help find a pattern in events that occur throughout the enterprise and to provide a way of assessing the respective model. Furthermore, the central repository contains relational databases in which the real-time data is held in normalized form and a space for modeling data sets in which reformatted data is held in denormalized form.

Advantages of the invention will be understood by those skilled in the art, in part, from the detailed description that follows.

### BRIEF DESCRIPTION OF THE DRAWINGS

The accompanying drawings, which are incorporated in and constitute a part of this specification, illustrate several representative embodiments of the invention. Wherever convenient, the same reference numbers will be used throughout the drawings to refer to the same or like elements.

FIG. 1 illustrates a ZLE framework that defines, in a representative embodiment, a multilevel architecture (ZLE architecture) centered on a virtual hub.

FIG. 2 illustrates in the representative embodiment the core of the ZLE framework.

FIG. 3 illustrates a ZLE framework with an application server supporting ZLE core services that are based on Tuxedo, CORBA or Java technologies.

FIGS. 4a-4f illustrate architectural and functional aspects of knowledge discovery through the analytic learning cycle in the ZLE environment.

FIG. 5 is a flow diagram demonstrating a model building stage.

FIG. 6 illustrates a decision tree diagram.

FIG. 7 shows the function and components of a ZLE solution in representative embodiments.

FIGS. 8-12 illustrate an approach taken in using data mining for fraud detection in a retail environment, as follows:

FIG. 8 shows an example application involving credit card fraud.

FIG. 9 shows a modeling data set.

FIG. 10 illustrates deriving predictor attributes.

FIG. 11 illustrates building a decision tree for the credit card fraud example.

FIG. 12 illustrates translating a decision tree to rules.

FIGS. 13-16, each shows an example of a confusion matrix for model assessment.

FIG. 17 shows assessment measures for a mining model in the credit card fraud example.

### DETAILED DESCRIPTION OF THE INVENTION

Servers host various mission-critical applications for enterprises, particularly large enterprises. One such mission-critical application is directed to customer-relations management (CRM). In conjunction with CRM, the interaction manager (IM) is an enterprise application that captures interactions with enterprise ‘customers’, gathers customers' data, calls upon a rules service to obtain offers customized for such customers and passes the offers to these customers. Other applications, although not addressing customer interactions, may nonetheless address the needs of information consumers in one way or the other. The term information consumers applies in general but not exclusively to persons within the enterprise, partners of the enterprise, enterprise customers, or even processes associated with the operations of the enterprise (e.g., manufacturing or inventory operations). In view of that, representative embodiments of the invention relate to handling information in a zero latency enterprise (ZLE) environment and, more specifically, to leveraging knowledge with analytical learning cycle techniques in the context of ZLE.

In order to leverage the knowledge effectively, analytical learning cycle techniques are deployed in the context of the ZLE environment in which there is a comprehensive, enterprise-wide real-time view of enterprise operations and information. By configuring the ZLE environment with an information technology (IT) framework that enables the enterprise to integrate its operations, applications and data in real time, the enterprise can function substantially without delays, hence the term zero latency enterprise (ZLE).

I. Zero Latency Enterprise (ZLE) Overview

In a representtaive embodiment, analytical learning cycle techniques operate in the context of the ZLE environment. Namely, the analytical learning cycle techniques are implemented as part of the scheme for reducing latencies in enterprise operations and for providing better leverage of knowledge acquired from data emanating throughout the enterprise. This scheme enables the enterprise to integrate its services, business rules, business processes, applications and data in real time. In other words, it enables the enterprise to run as a ZLE.

A. The ZLE Concept

Zero latency allows an enterprise to achieve coherent operations, efficient economics and competitive advantage. Notably, what is true for a single system is also true for an enterprise—reduce latency to zero and you have an instant response. An enterprise running as a ZLE, can achieve enterprise-wide recognition and capturing of business events that can immediately trigger appropriate actions across all other parts of the enterprise and beyond. Along the way, the enterprise can gain real-time access to a real-time, consolidated view of its operations and data from anywhere across the enterprise. As a result, the enterprise can apply business rules and policies consistently across the enterprise including all its products, services, and customer interaction channels. As a further result, the entire enterprise can reduce or eliminate operational inconsistencies, and become more responsive and economically efficient via a unified, up-to the-second view of information consumer interactions with any part(s) of the enterprise, their transactions, and their behavior. For example, an enterprise running as a ZLE and using its feedback mechanism can conduct instant, personalized marketing while the customer is engaged. This result is possible because of the real-time access to the customer's profile and enterprise-wide rules and policies (while interacting with the customer). What is more, a commercial enterprise running as a ZLE achieves faster time to market for new products and services, and reduces exposure to fraud, customer attrition and other business risks. In addition, any enterprise running as a ZLE has the tools for managing its rapidly evolving resources (e.g., workforce) and business processes.

B. The ZLE Framework and Architecture

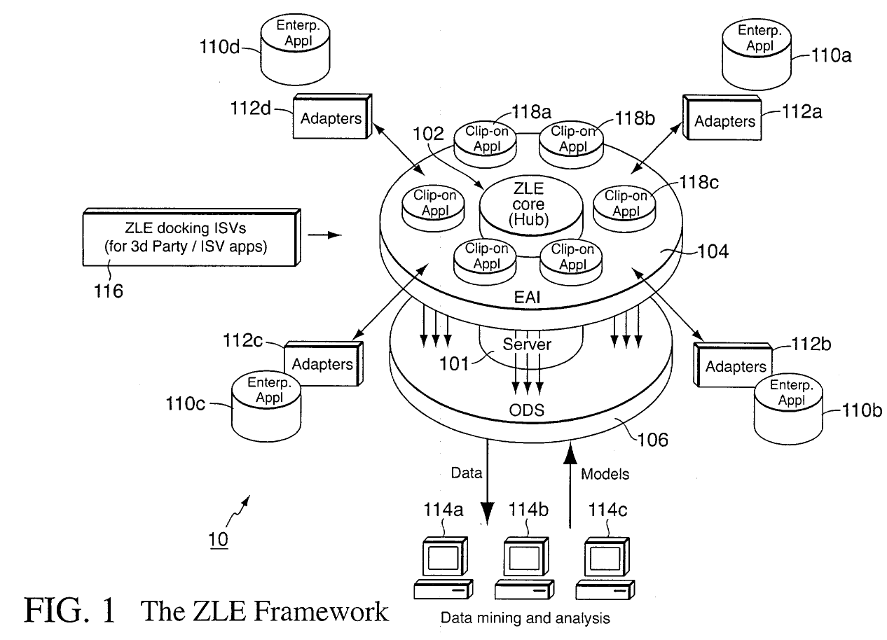

To become a zero latency enterprise, an enterprise integrates, in real time, its business processes, applications, data and services. Zero latency involves real-time recognition of business events (including interactions), and simultaneously synchronizing and routing information related to such events across the enterprise. As a means to that end, the aforementioned enterprise-wide integration for enabling the ZLE is implemented in a framework, the ZLE framework. FIG. 1 illustrates a ZLE framework.

As shown, the ZLE framework 10 defines a multilevel architecture, the ZLE architecture. This multilevel architecture provides much more than an integration platform with enterprise application integration (EAI) technologies, although it integrates applications and data across an enterprise; and it provides more comprehensive functionality than mere real time data warehousing, although it supports data marts and business intelligence functions. As a basic strategy, the ZLE framework is fashioned with hybrid functionality for synchronizing, routing, and caching, related data and business intelligence and for transacting enterprise business in real time. With this functionality it is possible to conduct live transactions against the ODS. For instance, the ZLE framework aggregates data through an operational data store (ODS) 106 and, backed by the ODS, the ZLE framework integrates applications, propagates events and routes information across the applications through the EAI 104. In addition, the ZLE framework executes transactions in a server 101 backed by the ODS 106 and enables integration of new applications via the EAI 104 backed by the ODS 106. Furthermore, the ZLE framework supports its feedback functionality which is made possible by knowledge discovery, through analytic learning cycles with data mining and analysis 114, and by a reporting mechanism. These functions are also backed by the ODS. The ODS acts as a central repository with cluster-aware relational data base management system (RDBMS) functionality. Importantly, the ZLE framework enables live transactions and integration and dissemination of information and propagation of events in real time. Moreover, the ZLE framework 10 is extensible in order to allow new capabilities and services to be added. Thus, the ZLE framework enables coherent operations and reduction of operational latencies in the enterprise.

The typical ZLE framework 10 defines a ZLE architecture that serves as a robust system platform capable of providing the processing performance, extensibility, and availability appropriate for a business-critical operational system. The multilevel ZLE architecture is centered on a virtual hub, called the ZLE core (or ZLE hub) 102. The enterprise data storage and caching functionality (ODS) 106 of the ZLE core 102 is depicted on the bottom and its EAI functionality 104 is depicted on the top. The architectural approach to combine EAI and ODS technologies retains the benefits of each and uses the two in combination to address the shortcomings of traditional methods as discussed above. The EAI layer, preferably in the form of the NonStop™ solutions integrator (by Hewlett-Packard Company), includes adapters that support a variety of application-to-application communication schemes, including messages, transactions, objects, and database access. The ODS layer includes a cache of data from across the enterprise, which is updated directly and in near real-time by application systems, or indirectly through the EAI layer.

In addition to an ODS acting as a central repository with cluster-aware RDBMS, the ZLE core includes core services and a transactions application server acting as a robust hosting environment for integration services and clip-on applications. These components are not only integrated, but the ZLE core is designed to derive maximum synergy from this integration. Furthermore, the services at the core of ZLE optimize the ability to integrate tightly with and leverage the ZLE architecture, enabling a best-of-breed strategy.

Notably, the ZLE core is a virtual hub for various specialized applications that can clip on to it and are served by its native services. The ZLE core is also a hub for data mining and analysis applications that draw data from and feed result-models back to the ZLE core. Indeed, the ZLE framework combines the EAI, ODS, OLTP (on-line transaction processing), data mining and analysis, automatic modeling and feedback, thus forming the touchstone hybrid functionality of every ZLE framework.

For knowledge discovery and other forms of business intelligence, such as on-line analytical processing (OLAP), the ZLE framework includes a set of data mining and analysis marts 114. Knowledge discovery through analytic learning cycles involves data mining. There are many possible applications of data mining in a ZLE environment, including: personalizing offers at the e-store and other touch-points; asset protection; campaign management; and real-time risk assessment. To that end, the data mining and analysis marts 114 are fed data from the ODS, and the results of any analysis performed in these marts are deployed back into the ZLE hub for use in operational systems. Namely, data mining and analysis applications 114 pull data from the ODS 106 at ZLE core 102 and return result models to it. The result models can be used to drive new business rules, actions, interaction management and so on. Although the data mining and analysis applications 114 are shown residing with systems external to the ZLE core, they can alternatively reside with the ZLE core 102.

In developing the hybrid functionality of a ZLE framework, any specialized applications—including those that provide new kinds of solutions that depend on ZLE services, e.g., interaction manager—can clip on to the ZLE core. Hence, as further shown in FIG. 1 the ZLE framework includes respective suites of tightly coupled and loosely coupled applications. Clip-on applications 118 are tightly coupled to the ZLE core 102, reside on top of the ZLE core, and directly access its services. Enterprise applications 110, such as SAP's enterprise resource planing (ERP) application or Siebel's customer relations management (CRM) application, are loosely coupled to the ZLE core (or hub) 102 being logically arranged around the ZLE core and interfacing with it via application or technology adapters 112. The docking of ISV (independent solution vendors) solutions such as the enterprise applications 110 is made possible with the ZLE docking 116 capability. The ZLE framework's open architecture enables core services and plug-in applications to be based on best-of-breed solutions from leading ISVs. This, in turn, ensures the strongest possible support for the full range of data, messaging, and hybrid demands.

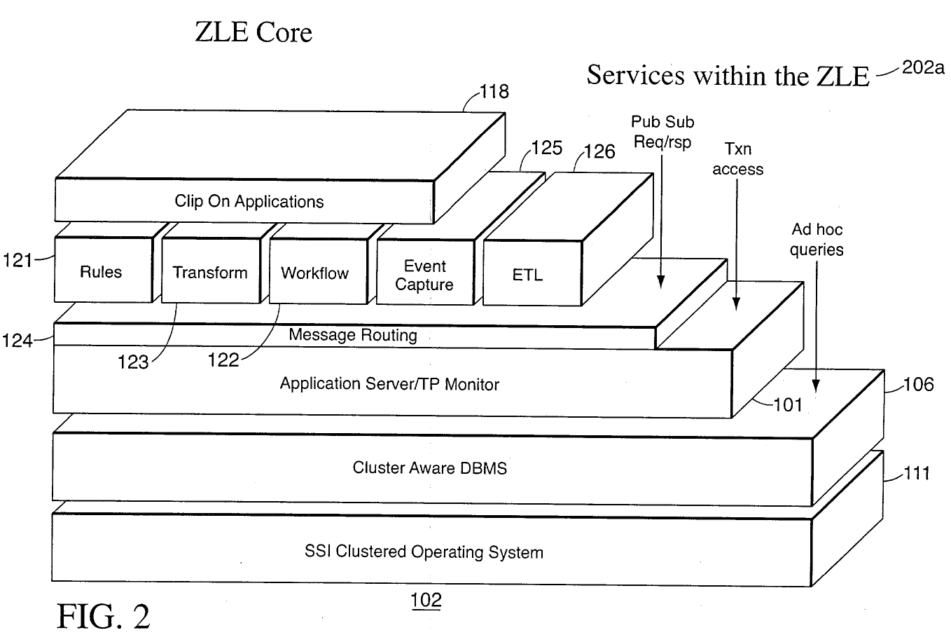

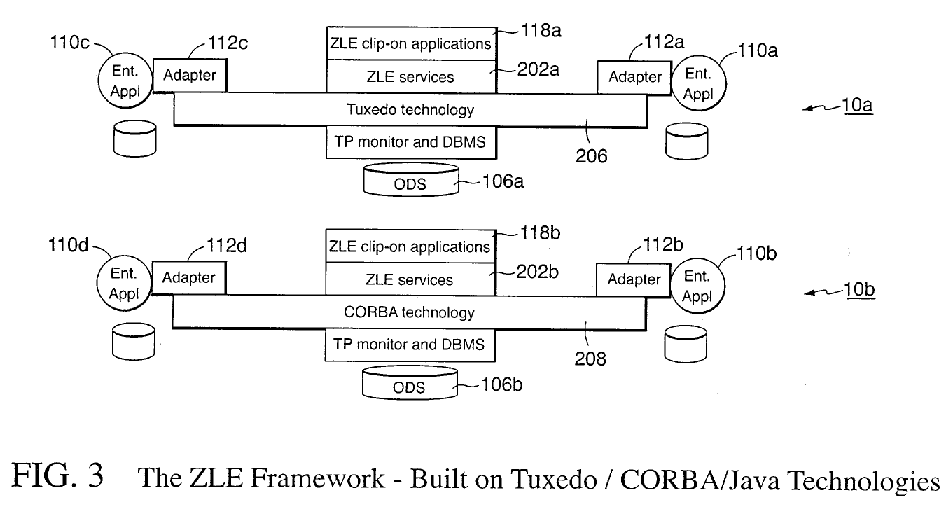

As noted, the specialized applications, including clip-on applications and loosely coupled applications, depend on the services at the ZLE core. The set of ZLE services—i.e., core services and capabilities—that reside at the ZLE core are shown in FIGS. 2 and 3. The core services 202 can be fashioned as native services and core ISV services (ISVs are third-party enterprise software vendors). The ZLE services 121-126 are preferably built on top of an application server environment founded on Tuxedo 206, CORBA 208 or Java technologies (CORBA stands for common object request broker architecture). The broad range of core services includes business rules, message transformation, workflow, and bulk data extraction services; and, many of them are derived from best-of-breed core ISVs services provided by Hewlett-Packard, the originator of the ZLE framework, or its ISVs.

Among these core services, the rules service 121 is provided for event-driven enterprise-wide business rules and policies creation, analysis and enforcement. The rules service itself is a stateless server (or context-free server). It does not track the current state and there is no notion of the current or initial states or of going back to an initial state. Incidentally, the rules service does not need to be implemented as a process pair because it is stateless, and a process pair is used only for a stateful server. It is a server class, so any instance of the server class can process it. Implemented using preferably Blaze Advisor, the rules service enables writing business rules using graphical user interface or syntax like a declarative, English-language sentence. Additionally, in cooperation with the interaction manager, the rules service 121 is designed to find and apply the most applicable business rule upon the occurrence of an event. Based on that, the rules service 121 is designed to arrive at the desired data (or answer, decision or advice) which is uniform throughout the entire enterprise. Hence this service may be referred to as the uniform rules service. The rules service 121 allows the ZLE framework to provide a uniform rule-driven environment for flow of information and supports its feedback mechanism (through the IM). The rules service can be used by the other services within the ZLE core, and any clip-on and enterprise applications that an enterprise may add, for providing enterprise-wide uniform treatment of business rules and transactions based on enterprise-wide uniform rules.

Another core service is the extraction, transformation, and load (ETL) service 126. The ETL service 126 enables large volumes of data to be transformed and moved quickly and reliably in and out of the database (often across databases and platform boundaries). The data is moved for use by analysis or operational systems as well as by clip-on applications.

Yet another core service is the message transformation service 123 that maps differences in message syntax, semantics, and values, and it assimilates diverse data from multiple diverse sources for distribution to multiple diverse destinations. The message transformation service enables content transformation and content-based routing, thus reducing the time, cost, and effort associated with building and maintaining application interfaces.

Of the specialized applications that depend on the aforementioned core services, clip-on applications 118, literally clip on to, or are tightly coupled with, the ZLE core 102. They are not standalone applications in that they use the substructure of the ZLE core and its services (e.g., native core services) in order to deliver highly focused, business-level functionality of the enterprise. Clip-on applications provide business-level functionality that leverages the ZLE core's real-time environment and application integration capabilities and customizes it for specific purposes. ISVs (such as Trillium, Recognition Systems, and MicroStrategy) as well as the originator of the ZLE framework (formerly Compaq Computer Corporation and now a part of Hewlett-Packard Corporation) can contribute value-added clip-on applications such as for fraud detection, customer interaction and personalization, customer data management, narrowcasting notable events, and so on. A major benefit of clip-on applications is that they enable enterprises to supplement or update their ZLE core or core ISV services by quickly implementing new services. Examples of clip-on applications include the interaction manager, narrowcaster, campaign manager, customer data manager, and more.

The interaction manager (IM) application 118 (by Hewlett-Packard Corporation) leverages the rules engine 121 within the ZLE core to define complex rules governing customer interactions across multiple channels. The IM also adds a real-time capability for inserting and tracking each customer transaction as it occurs so that relevant values can be offered to consumers based on real-time information. To that end, the IM interacts with the other ZLE components via the ODS. The IM provides mechanisms for initiating sessions, for loading customer-related data at the beginning of a session, for caching session context (including customer data) after each interaction, for restoring session context at the beginning of each interaction and for forwarding session and customer data to the rules service in order to obtain recommendations or offers. The IM is a scalable stateless server class that maintains an unlimited number of concurrent customer sessions. The IM stores session context in a table (e.g., NonStop structured query language (SQL) table). Notably, as support for enterprise customers who access the ZLE server via the Internet, the IM provides a way of initiating and resuming sessions in which the guest may be completely anonymous or ambiguously identified. For each customer that visits the enterprise web site, the interface program assigns a unique cookie and stores it on the enterprise customer's computer for future reference.

In general, although the IM is responsible for capturing the interactions and or forwarding interaction data and aggregates to the rules service, a data preparation tool (e.g., Genus Mart Builder, or Genus Mart Builder for NonStop™ SQL, by Genus Software, Inc.) is responsible for selectively gathering the interactions and customer information in the aggregates, both for the IM and for data mining. As will be later explained in more detail, behavior patterns are discovered through data mining and models produced therefrom are deployed to the ODS by a model deployment tool. The behavior models are stored at the ODS for later access by applications such as a scoring service in association with the rules service (also referred to as scoring engine and rules engine, respectively). These services are deployed in the ZLE environment so that aggregates produced for the IM can be scored with the behavior models when forwarded to the rules service. A behavior model is used in fashioning an offer to the enterprise customers. Then, data mining is used to determine what patterns predict whether a customer would accept or not accept an offer. Customers are scored so that the IM can appropriately forward the offer to customers that are likely to accept it. The behavior models are created by the data mining tool based on behavior patterns it discovers. The business rules are different from the behavior models in that they are assertions in the form of pattern-oriented predictions. For example, a business rule looking for a pattern in which X is true can assert that “Y is the case if X is true.” Business rules are often based on policy decisions such as “no offer of any accident insurance shall be made to anyone under the age of 25 that likes skiing,” and to that end the data mining tool is used to find who is accident prone. From the data mining a model emerges that is then used in deciding which customer should receive the accident insurance offer, usually by making a rule-based decision using threshold values of data mining produced scores. However, behavior models are not always followed as a prerequisite for making an offer, especially if organization or business policies trump rules created from such models. There may be policy decisions that force overwriting the behavior model or not pursuing the business model at all, regardless of whether a data mine has been used or not.

As noted before, the enumerated clip-on applications include also the campaign manager application. The campaign manager application, can operate in a recognition system such as the data mining and analysis system (114, FIG. 1) to leverage the huge volumes of constantly refreshed data in the ODS of the ZLE core. The campaign manager directs and fine-tunes campaigns based on real-time information gathered in the ODS.

Another clip-on application, the customer data manager application, leverages customer data management software to synchronize, delete, duplicate, and cleanse customer information across legacy systems and the ODS in order to create a unified and correct customer view. Thus, the customer data management application is responsible for maintaining a single, enriched and enterprise-wide view of the customer. The tasks performed by the customer manager include: de-duplication of customer information (e.g., recognizing duplicate customer information resulting from minor spelling differences), propagating changes to customer information to the ODS and all affected applications, and enriching internal data with third-party information (such as demographics, psycho-graphics and other kinds of information).

Fundamentally, as a platform for running these various applications, the ZLE framework includes elements that are modeled after a transaction processing (TP) system. In broad terms, a TP system includes application execution and transaction processing capability, one or more databases, tools and utilities, networking functionality, an operating system and a collection of services that include TP monitoring. A key component of any TP system is a server. The server is capable of parallel processing, and it supports concurrent TP, TP monitoring and management of transactions-flow through the TP system. The application server environment advantageously can provide a common, standard-based framework for interfacing with the various ZLE services and applications as well as ensuring transactional integrity and system performance (including scalability and availability of services). Thus, the ZLE services 121-126 are executed on a server, preferably a clustered server platforms 101 such as the NonStop™ server or a server running a UNIX™ operating system 111. These clustered server platforms 101 provide the parallel performance, extensibility (e.g., scalability), and availability typically requisite for business-critical operations.

In one configuration, the ODS is embodied in the storage disks within such server system. NonStop™ server systems are highly integrated fault tolerant systems and do not use externally attached storage. The typical NonStop™ server system will have hundreds of individual storage disks housed in the same cabinets along with the CPUs, all connected via a server net fabric. Although all of the CPUs have direct connections to the disks (via a disk controller), at any given time a disk is accessed by only one CPU (one CPU is primary, another CPU is backup). One can deploy a very large ZLE infrastructure with one NonStop™ server node. In one example the ZLE infrastructure is deployed with 4 server nodes. In another example, the ZLE infrastructure is deployed with 8 server nodes.

The ODS with its relational database management system (RDBMS) functionality is integral to the ZLE core and central to achieving the hybrid functionality of the ZLE framework (106 FIG. 1). The ODS 106 provides the mechanism for dynamically integrating data into the central repository or data store for data mining and analysis, and it includes the cluster-aware RDBMS functionality for handling periodic queries and for providing message store functionality and the functionality of a state engine. To that end, the ODS is based on a scalable database and it is capable of performing a mixed workload. The ODS consolidates data from across the enterprise in real time and supports transactional access to up-to-the-second data from multiple systems and applications, including making real-time data available to data marts and business intelligence applications for real-time analysis and feedback.

As part of this scheme, the RDBMS is optimized for massive real-time transaction, real-time loads, real-time queries, and batch-extraction. The cluster-aware RDBMS is able to support the functions of an ODS containing current-valued, subject-oriented, and integrated data reflecting the current state of the systems that feed it. As mentioned, the preferred RDBMS can also function as a message store and a state engine, maintaining information as long as required for access to historical data. It is emphasized that ODS is a dynamic data store and the RDBMS is optimized to support the function of a dynamic ODS.

The cluster-aware RDBMS component of the ZLE core is, in this embodiment, either the NonStop™ SQL database running on the NonStop™ server platform (from Hewlett-Packard Corporation) or Oracle Parallel Server (from Oracle Corporation) running on a UNIX system. In supporting its ODS role of real-time enterprise data cache, the RDBMS contains preferably three types of information: state data, event data and lookup data. State data includes transaction state data or current value information such as a customer's current account balance. Event data includes detailed transaction or interaction level data, such as call records, credit card transactions, Internet or wireless interactions, and so on. Lookup data includes data not modified by transactions or interactions at this instant (i.e., an historic account of prior activity).

Overall, the RDBMS is optimized for application integration as well as real-time transactional data access and updates and queries for business intelligence and analysis. For example, a customer record in the ODS (RDBMS) might be indexed by customer ID (rather than by time, as in a data warehouse) for easy access to a complete customer view. In this embodiment, key functions of the RDBMS include dynamic data caching, historical or memory data caching, robust message storage, state engine and real-time data warehousing.

The state engine functionality allows the RDBMS to maintain real-time synchronization with the business transactions of the enterprise. The RDBMS state engine function supports workflow management and allows tracking the state of ongoing transactions (such as where a customer's order stands in the shipping process) and so on.

The dynamic data caching function aggregates, caches and allows real-time access to real-time state data, event data and lookup data from across the enterprise. Thus, for example, this function obviates the need for contacting individual information sources or production systems throughout the enterprise in order to obtain this information. As a result, this function greatly enhances the performance of the ZLE framework.

The historical data caching function allows the ODS to also supply a historic account of events that can be used by newly added enterprise applications (or clip-on applications such as the IM). Typically, the history is measured in months rather than years. The historical data is used for enterprise-critical operations including for transaction recommendations based on customer behavior history.

The real-time data warehousing function of the RDBMS supports the real-time data warehousing function of the ODS. This function can be used to provide data to data marts and to data mining and analysis applications. Data mining plays an important role in the overall ZLE scheme in that it helps understand and determine the best ways possible for responding to events occurring throughout the enterprise. In turn, the ZLE framework greatly facilitates data mining by providing an integrated, data-rich environment. For that, the ZLE framework embodies also the analytic learning cycle techniques as will be later explained in more detail.

It is noted that this applies to any event that may occur during enterprise operations, including customer interactions, manufacturing process state changes, inventory state changes, threshold(s) exceeded in a government monitoring facility or anything else imaginable. Customer interactions are easier events to explain and are thus used as an example more frequently throughout this discussion.

It also is noted that in the present configuration the data mine is set up on a Windows NT (from Microsoft Corporation) or a Unix system because present (data mining) products are not suitable for running directly on the NonStop™ server systems. One such product, a third party application specializing in data mining, is SAS Enterprise Miner by SAS®. Then, the Genus Mart Builder (from Genus Software, Inc.) is a component pertaining to the data preparation area where aggregates are collected and moved off into the SAS Enterprise Miner. Future configurations with a data mine may use different platforms as they become compatible.

It is further noted that Hewlett-Packard®, Compaq@, Compaq ZLE™, AlphaServer™, NonStop™, and the Compaq logo, are trademarks of the Hewlett-Packard Company (formerly Compaq Computer Corporation of Houston, Tex.), and UNIX® is a trademark of the Open Group. Any other product names may be the trademarks of their respective originators.

In sum an enterprise equipped to run as a ZLE is capable of integrating, in real time, its enterprise-wide data, applications, business transactions, operations and values. Consequently, an enterprise conducting its business as a ZLE exhibits superior management of its resources, operations, supply-chain and customer care.

II. Knowledge Discovery through ZLE Analytic Learning Cycle

The following sections describe knowledge discovery through the ZLE analytic learning cycle and related topics in the context of the ZLE environment. First an architectural and functional overview is presented. Then, a number of examples illustrate, with varying degrees of details, implementation of these concepts.

A. Conceptual, Architectural, and Functional Overview

Knowledge discovery through ZLE analytic learning cycle generally involves the process and collection of methods for data mining and learning cycles. These include: 1) preparing a historical data set for analysis that provides a comprehensive, integrated and current (real-time) view of an enterprise; 2) using advanced data mining analytical techniques to extract knowledge from this data in the form of predictive models; and 3) deploying such models into applications and operational systems in a way that the models can be utilized to respond effectively to business events. As a result of building and applying predictive models the analytic learning cycle is performed each time quickly and in a way that allows learning from one cycle to the next. To that end, ZLE analytic learning cycles use advanced analytical techniques to extract knowledge from current, comprehensive and integrated data in a ZLE Data Store (ODS). The ZLE analytic learning cycles enables ZLE applications (e.g., IM) to use the extracted knowledge for responding to business events in real-time in an effective and customized manner based on up-to-the-second (real-time) data. The responses to business events are themselves recorded in the ZLE Data Store, along with other relevant data, allowing each knowledge extraction-and-utilization cycle to learn from previous cycles. Thus, the ZLE framework provides an integrating environment for the models that are deployed, for the data applied to the models and for the model-data analysis results.

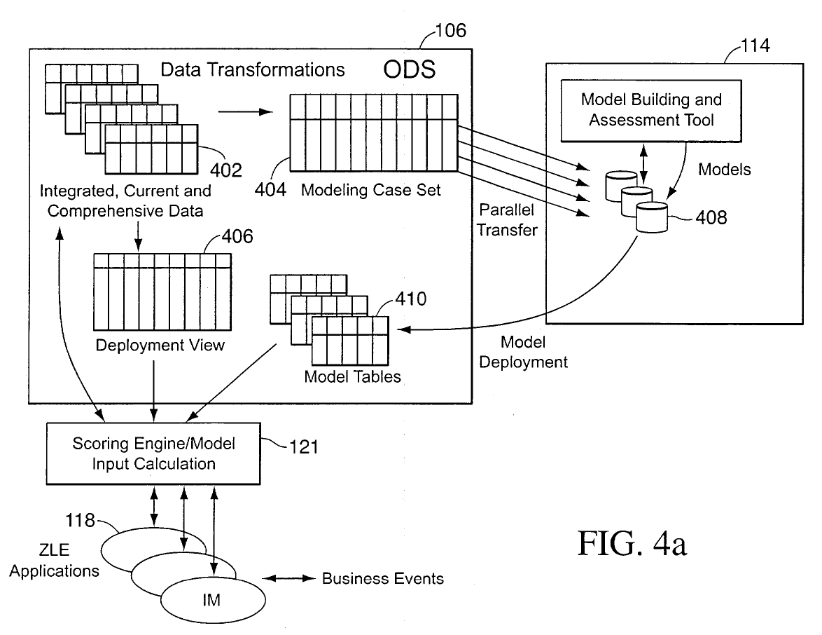

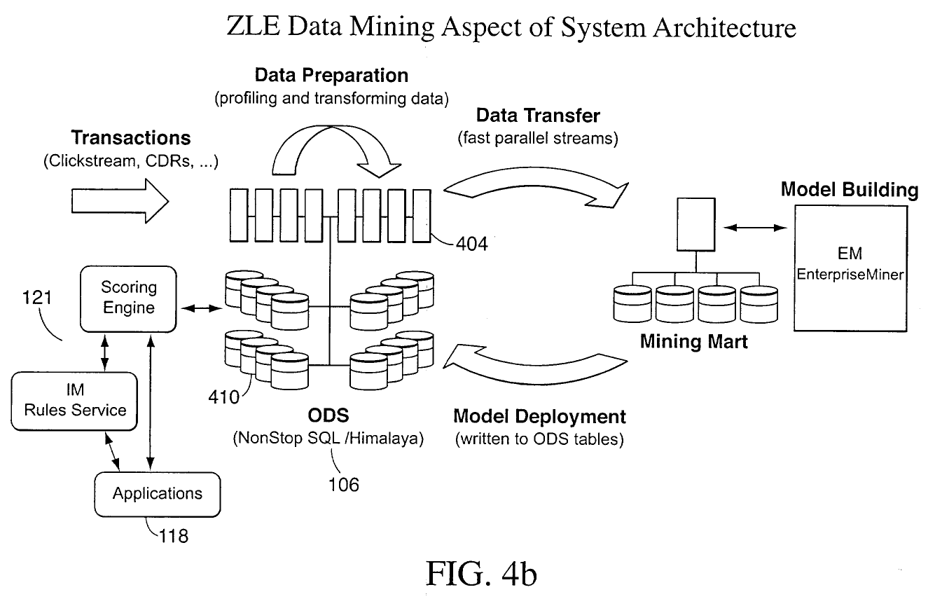

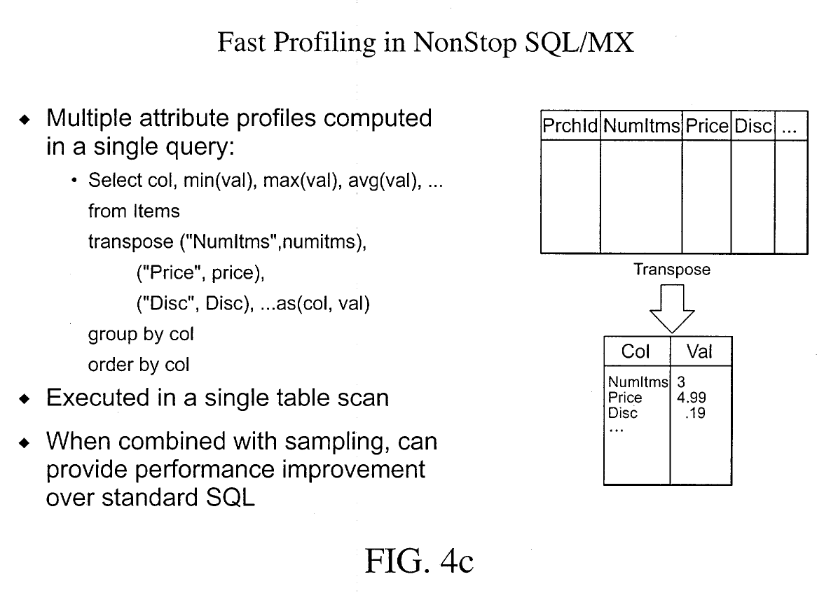

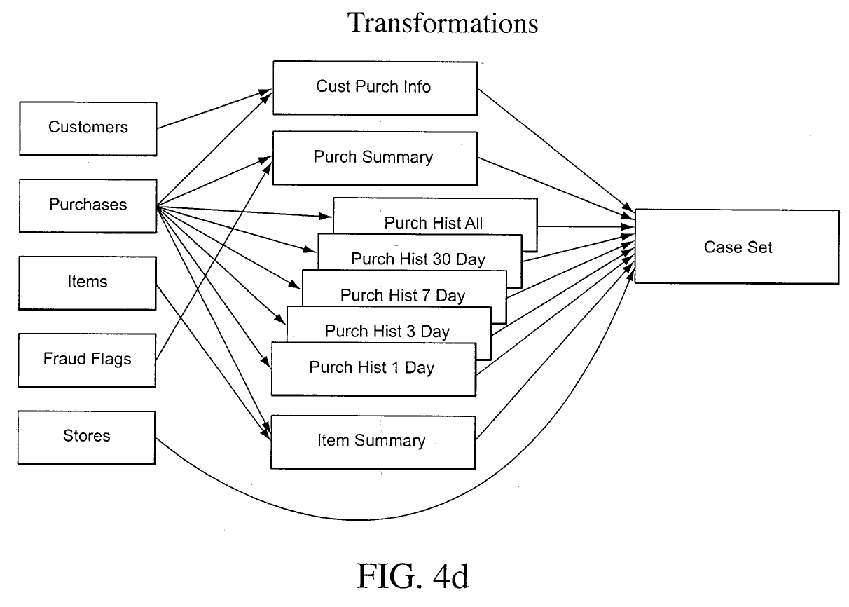

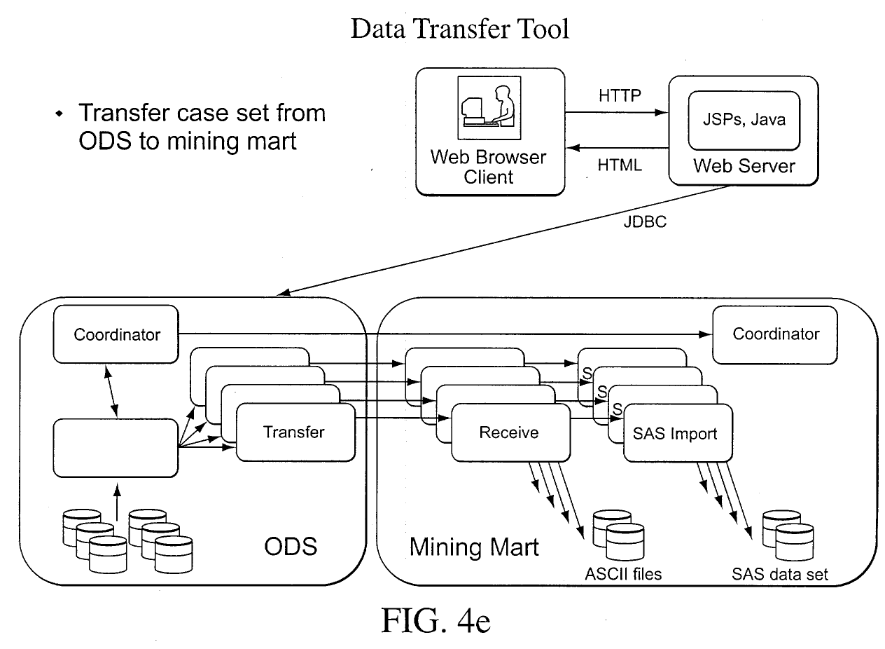

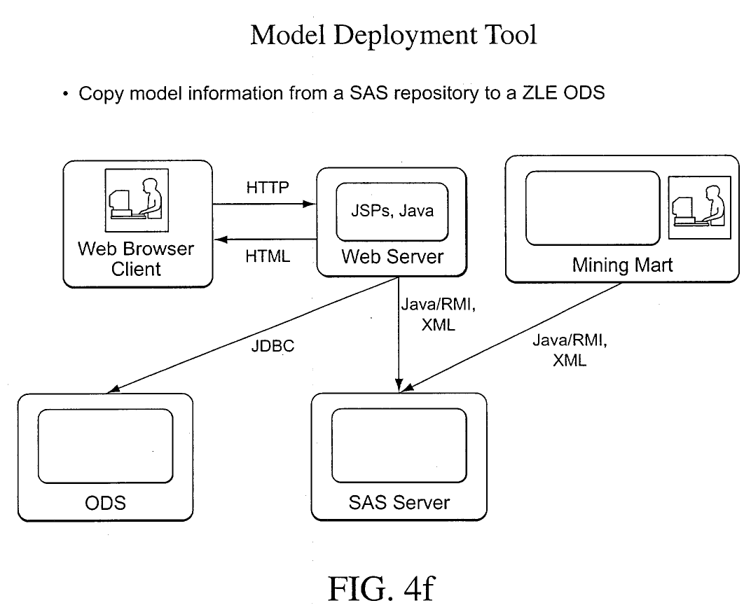

FIGS. 4a-4f illustrate architectural and functional aspects of knowledge discovery through the analytic learning cycle in the ZLE environment. A particular highlight is made of data mining as part of the ZLE learning cycle. As shown in FIGS. 4a-f, and will be later explained in more detail, the analytic learning cycle is associated with taking and profiling data gathered in the ODS 106, transforming the data into modeling case sets 404, transferring the model case sets, building models 408 and deploying the models into model tables 410 in the ODS. As further shown, the scoring engine 121 reads the model tables 410 in the ODS and executes the models, as well as interfaces with other ZLE applications (such as the IM) that need to use the models in response to various events.

As noted, the ZLE analytic learning cycle involves data mining. Data mining techniques and the ZLE framework architecture described above are very synergistic in the sense that data mining plays a key role in the overall solution and the ZLE solution infrastructure, in turn, greatly facilitates data mining. Data mining is a way of getting insights into the vast transaction volumes and associated data generated across the enterprise. For commercial entities such as hotel chains, securities dealers, banks, supply chains or others, data mining helps focus marketing efforts and operations cost-effectively (e.g., by identifying individual customer needs, by identifying ‘good’ customers, by detecting securities fraud or by performing other consumer-focused or otherwise customized analysis). Likewise, for national or regional government organizations data mining can help focus their investigative efforts, public relation campaigns and more.

Typically, data mining is thought of as analysis of data sets along a single dimension. Fundamentally, data mining is a highly iterative, non-sequential bottoms-up data-driven analysis that uses mathematical algorithms to find patterns in the data. As a frame of reference, although it is not necessarily used for the present analytic learning cycle, on-line analytical processing (OLAP) is a multi-dimensional process for analyzing patterns reduced from applying data to models created by the data mining. OLAP is a bottoms-down, hypothesis-driven analysis. OLAP requires an analyst to hypothesize what a pattern might be and then vary the hypothesis to produce a better result. Data mining facilitates finding the patterns to be presented to the analyst for consideration.

In the context of the ZLE analytic learning cycle, the data mining tool analyzes the data sets in the ODS looking for factors or patterns associated with attribute(s) of interest. For example, for data sets gathered in the ODS that represent the current and historic data of purchases from across the enterprise the data mining tool can look for patterns associated with fraud. A fraud may be indicated in values associated with number of purchases, certain times of day, certain stores, certain products or other analysis metrics. Thus, in conjunction with the current and historic data in the ODS, including data resulting from previous analytic learning cycles, the data mining tool facilitates the ZLE analytic learning cycles or, more broadly, the process of knowledge discovery and information leveraging.

Fundamentally, a ZLE data mining process in the ZLE environment involves defining the problem, exploring and preparing data accumulated in the ODS, building a model, evaluating the model, deploying the model and applying the model to input data. To start with, problem definition creates an effective statement of the problem and it includes a way of measuring the results of the proposed solution.

The next phase of exploring and preparing the data in the ZLE environment is different from that of traditional methods. In traditional methods, data resides in multiple databases associated with different applications and disparate systems resident at various locations. For example, the deployment of a model that predicts, say, whether or not a customer will respond to an e-store offer, may require gathering customer attributes such as demographics, purchase history, browse history and so on, from a variety of systems. Hence, data mining in traditional environments calls for integration, consolidation, and reconciliation of the data each time it goes to this phase. By comparison, in a ZLE environment the data preparation work for data mining is greatly simplified because all current information is already present in the ODS where it is integrated, consolidated and reconciled. Unlike traditional methods, the ODS in the ZLE environment accumulates real-time data from across the enterprise substantially as fast as it is created such that the data is ready for any application including data mining. Indeed, all (real-time) data associated with events throughout the enterprise is gathered in real time at the ODS from across the enterprise and is available there for data mining along with historical data (including prior responses to events).

Then, with the data being already available in proper form in the ODS, certain business-specific variables or predictors are determined or predetermined based on the data exploration. Selection of such variables or predictors comes from understanding the data in the ODS and the data can be explored using graphics or descriptive aids in order to understand the data. For example, predictors of risk can be constructed from raw data such as demographics and, say, debt-to-income ratio, or credit card activity within a time period (using, e.g., bar graphs, charts, etc.). The selected variables may need to be transformed in accordance with the requirements of the algorithm chosen for building the model.

In the ZLE environment, tools for data preparation provide intuitive and graphical interfaces for viewing the structure and content of data tables/databases in the ODS. The tools provide also interfaces for specifying the transformations needed to produce a modeling case set or deployment view table from the available source tables (as shown for example in FIG. 4d). Transformation involves reformatting data to the way it is used for model building or for input to a model. For example, database or transaction data containing demographics (e.g., location, income, equity, debt, . . . ) is transformed to produce ratios of demographics values (e.g., debt-equity-ratio, average-income, . . . ). Other examples of transformation include reformatting data from a bit-pattern to a character string, and transforming a numeric value (e.g., >100) to a binary value (Yes/No). The table viewing and transformation functions of the data preparation tools are performed through database queries issued to the RDBMS at the ODS. To that end, the data is reconciled and properly placed at the ODS in relational database(s)/table(s) where the RDBMS can respond to the queries.

Generally, data held in relational databases/tables is organized in normalized table form where instead of having a record with multiple fields for a particular entry item, there are multiple records each for a particular instance of the entry item. What is generally meant by normalized form is that different entities are stored in different tables and if entities have different occurrence patterns (or instances) they are stored in separate records rather than being embedded. One of the attributes of normalized form is that there are no multi-value dependencies. For example, a customer having more than one address or more than one telephone number will be associated with more than one record. What this means is that for a customer with three different telephone numbers there is a corresponding record (row) for each of the customer's telephone numbers. These records can be distinguished and prioritized, but to retrieve all the telephone numbers for that customer, all three records are read from the customer table. In other words, the normalized table form is optimal for building queries. However, since the normalized form involves reading multiple records of the normalized table, it is not suitable for fast data access.

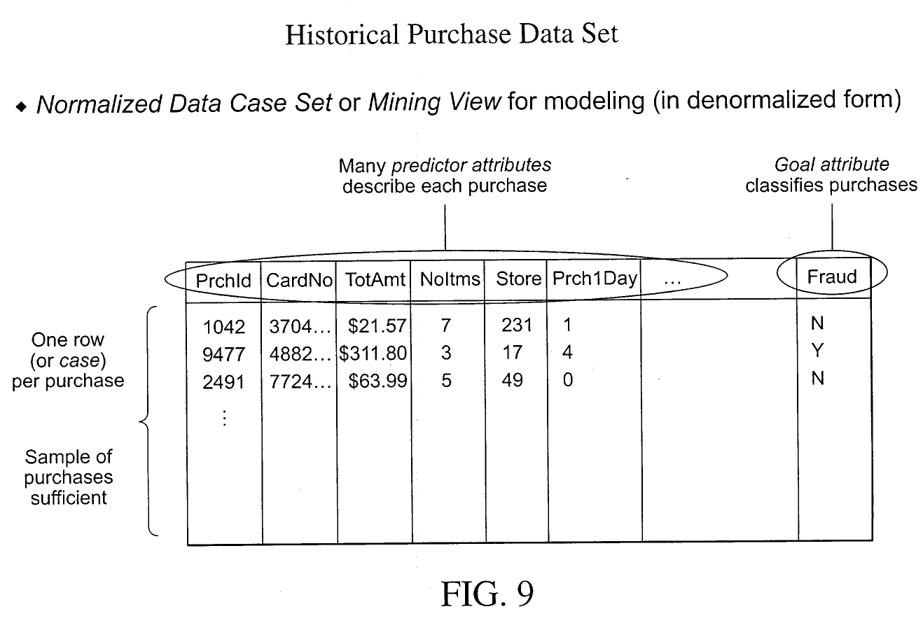

By comparison, denormalized form is better for fast access, although denormalized data is not suitable for queries. And so what is further distinctive about the data preparation in the ZLE environment is the creation of a denormalized table in the ODS that is referred to as the modeling case set (404, FIG. 4a). Indeed, this table contains comprehensive and current data from the ZLE Data Store, including any results obtained through the use of predictive models produced by previous analysis cycles. Structurally (as later shown for example in FIG. 9), the modeling case set contains one row per entity (such as customer, web session, credit card account, manufacturing lot, securities fraud investigation or whatever is the subject of the planned analysis). The denormalized form is fashioned by taking the data in the normalized form and caching it lined up flatly and serially, end-to-end, in a logically contiguous record so that it can be quickly retrieved and forwarded to the model building and assessment tool.

The modeling case set formed in the ODS is preferably transferred in bulk out of the ODS to a data mining server (e.g., 114, FIG. 4a) via multiple concurrent streams. The efficient transfer of case sets from the ODS to the data mining server is performed via another tool that provides an intuitive and graphical interface for identifying a source table, target files and formats, and various other transfer options (FIG. 4e). Transfer options include, for example, the number of parallel streams to be used in the transfer. Each stream transfers a separate horizontal partition (row) of the table or a set of logically contiguous partitions. The transferred data is written either to fixed-width/delimited ASCII files or to files in the native format of the data mining tool used for building the models. The transferred data is not written to temporary disk files, and it is not placed on disk again until it is written to the destination files.

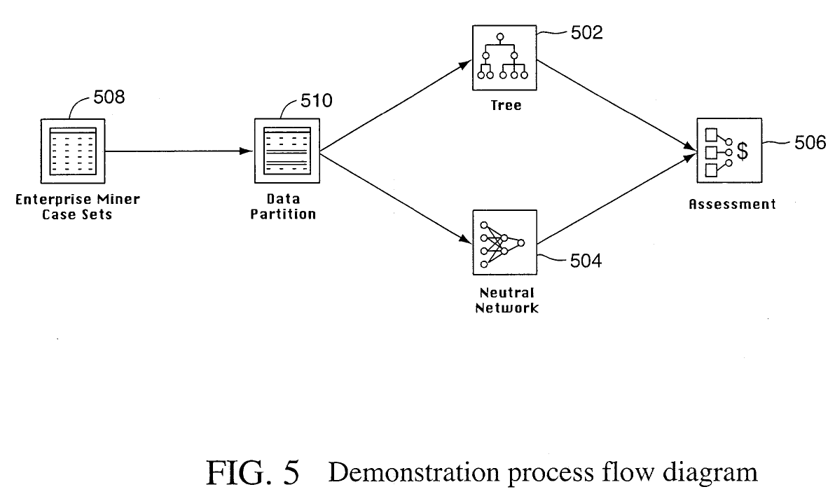

Next, the model building stage of the learning cycle involves the use of data mining tools and algorithms in the data mining server. FIG. 5 is a flow diagram that demonstrates a model building stage. The data mining tools and algorithms are used to build predictive models (e.g. 502, 504) from transferred case sets 508 and to assess model quality characteristics such as robustness, predictive accuracy, and false positive/negative rates (element 506). As mentioned before, data mining is an iterative process. One has to explore alternative models to find the most useful model for addressing the problem. For a given modeling data set, one method for evaluating a model involves determining the model 506 based on part of that data and testing such model for the remaining part of that data. What an enterprise data mining application developer or data mining analyst learns from the search for a good model may lead such analyst to go back and make some changes to the data collected in the modeling data set or to modify the problem statement.

Model building focuses on providing a model for representing the problem or, by analogy, a set or rules and predictor variables. Any suitable model type is applicable here, including, for instance, a ‘decision tree’ or a ‘neural network’. Additional model types include a logistic regression, a nearest neighbor model, a Naïve Bayes model, or a hybrid model. A hybrid model combines several model types into one model.

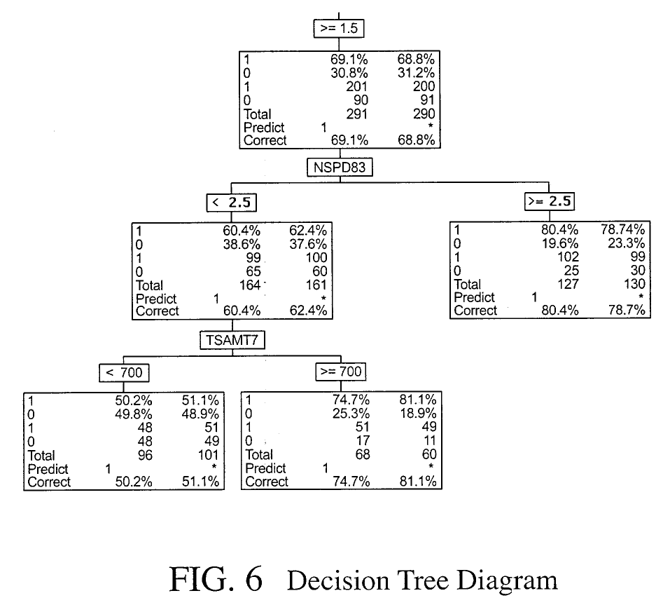

Decision trees, as shown for example in FIG. 6, represent the problem as a series of rules that lead to a value (or decision). A tree has a decision node, branches (or edges), and leaf nodes. The component at the top of a decision tree is referred to as the root decision node and it specifies the first test to be carried out. Decision nodes (below the root) specify subsequent tests to be carried out. The tests in the decision nodes correspond to the rules and the decisions (values) correspond to predictions. Each branch leads from the corresponding node to another decision node or to a leaf node. A tree is traversed, starting at the root decision node, by deciding which branch to take and moving to each subsequent decision node until a leaf is reached where the result is determined.

The second model type mentioned here is the neural network which offers a modeling format suitable for complex problems with a large number of predictors. A network is formatted with an input layer, any number of hidden layers, and an output layer. The nodes in the input layer correspond to predictor variables (numeric input values). The nodes in the output layer correspond to result variables (prediction values). The nodes in a hidden layer may be connected to nodes in another hidden layer or to nodes in the output layer. Based on this format, neural networks are traversed from the input layer to the output layer via any number of hidden layers that apply a certain function to the inputs and produce respective outputs.

For performing model building and assessment the data mining server employs SAS® Enterprise Miner™, or other leading data mining tools. As a demonstration relative to this, we describe a ZLE data mining application using SAS® Enterprise Miner™ to detect retail credit card fraud (SAS® and Enterprise Miner™ are registered trademarks or trademarks of SAS Institute Inc.). This application is based on a fraud detection study done with a large U.S. retailer. The real-time, comprehensive customer information available in a ZLE environment enables effective models to be built quickly in the Enterprise Miner™. The ZLE environment allows these models to be deployed easily into a ZLE ODS and to be executed against up-to-the-second information for real-time detection of fraudulent credit card purchases. Hence, employing data mining in the context of a ZLE environment enables companies to respond quickly and effectively to business events.

Typically, more than one model is built. Then, in the model deployment stage the resulting models are copied from the server on which they were built directly into a set of tables in the ODS. In one implementation, model deployment is accomplished via a tool that provides an intuitive and graphical interface for identifying models for deployment and for specifying and writing associated model information into the ODS (FIG. 4f). The model information stored in the tables includes: a unique model name and version number; the names and data types of model inputs and outputs; a specification of how to compute model inputs from the ODS; and a description of the model prediction logic, such as a set of IF-THEN rules or Java code.

Generally, in the execution stage an application that wants to use a model causes the particular model to be fetched from the ODS which is then applied to a set of inputs repeatedly (e.g., to determine the likelihood of fraud for each credit card purchase). Individual applications (such as a credit card authorization system) may call the scoring engine directly to use a model. However, in many cases applications call the scoring engine indirectly through the interaction manager (IM) application or rules engine (rules service). In one example, a credit card authorization system calls the IM which, in turn, calls the rules engine and scoring engine to determine the likelihood of fraud for a particular purchase.

As implemented in a typical ZLE environment the scoring engine (e.g., 121, FIG. 4a) is a Java code module(s) that performs the operations of fetching a particular model version from the ODS, applying the fetched model to a set of inputs, and returning the outputs (resulting predictions) to the calling ZLE application. The scoring engine identifies selected models by their name and version. Calling applications 118 use the model predictions, and possibly other business logic, to determine the most effective response to a business event. Importantly, predictions made by the scoring engine, and related event outcomes, are logged in the ODS, allowing future analysis cycles to learn from previous ones.

The scoring engine can read and execute models that are represented in the ODS as Java code or PMML (Predictive Model Markup Language, an industry standard XML-based representation). When applying a model to the set of inputs, the scoring engine either executes the Java code stored in the ODS that implements the model, or interprets the PMML model representation.

A model input calculation engine (not shown), which is a companion component to the scoring engine, processes the inputs needed for model execution. Both, the model input calculation engine and the scoring engine are ZLE components that can be called by ZLE applications, and they are typically written in Java. The model input calculation engine is designed to support calculations for a number of input categories. One input category is slowly changing inputs that are precomputed periodically (e.g., nightly) and stored at the ODS in a deployment view table, or a set of related deployment view tables. A second input category is quickly changing inputs computed as-needed from detailed and recent (real-time) event data in the ODS. The computation of these inputs is performed based on the input specifications in the model tables at the ODS.

It is noted that the aforementioned tools and components as used in the preferred implementation support interfaces suitable for batch execution, in addition to interfaces such as the graphical and interactive interfaces described above. In turn, this contributes to the efficiency of the ZLE analytic learning cycle. It is further noted that the faster ZLE analytic learning cycles mean that knowledge can be acquired more efficiently, and that models can be refreshed more often, resulting in more accurate model predictions. Unlike traditional methods, the ZLE analytic learning cycle effectively utilizes comprehensive and current information from a ZLE data store, thereby enhancing model prediction accuracy even further. Thus, a ZLE environment greatly facilitates data mining by providing a rich, integrated data source, and a platform through which mining results, such as predictive models, can be deployed quickly and flexibly.

B. Implementation Example—A ZLE Solution for Retail CRM

The previous sections outlined the principles associated with knowledge discovery through analytic learning cycle with data mining. In this section, we discuss the application of a ZLE solution to customer relationship management (CRM) in the retail industry. We then describe an actual implementation of the foregoing principles as developed for a large retailer.

1. The Need for Personalized Customer Interactions

Traditionally, the proprietors at neighborhood stores know their customers and can suggest products likely to appeal to their customers. This kind of personalized service promotes customer loyalty, a cornerstone of every retailer's success. By comparison, it is more challenging to promote customer loyalty through personalized service in today's retail via the Internet and large retail chains. In these environments, building a deep understanding of customer preferences and needs is difficult because the interactions that provide this information are scattered across disparate systems for sales, marketing, service, merchandize returns, credit card transactions, and so on. Also, customers have many choices and can easily shop elsewhere.

To keep customers coming back, today's retailers need to find a way to recapture the personal touch. They need comprehensive knowledge of the customer that encompasses the customer's entire relationship with the retail organization. Equally important is the ability to act on that knowledge instantaneously—for example, by making personalized offers during every customer interaction, no matter how brief.

An important element of interacting with customers in a personalized way is having available a single, comprehensive, current, enterprise-wide view of the customer-related data. In traditional retail environments, retailers typically have a very fragmented view of customers resulting from the separate and often incompatible computer systems for gift registry, credit card, returns, POS, e-store, and so on. So, for example, if a customer attempts to return an item a few days after the return period expired, the person handling the return and refund request is not likely to know whether the customer is loyal and profitable and merits leniency. Similarly, if a customer has just purchased an item, the marketing department is not made aware that the customer should not be sent discount offers for that item in the future.

As noted before, the ZLE framework concentrates the information from across the enterprise in the ODS. Thus, customer information integrated at the ODS from all channels enables retailers to make effective, personalized offers at every customer interaction-point (be it the brick-and-mortar store, call center, online e-store, or other.). For example, an e-store customer who purchased gardening supplies at a counterpart brick-and-mortar store can be offered complementary outdoor products next time that customer visits the e-store web site.

2. A ZLE Retail Implementation

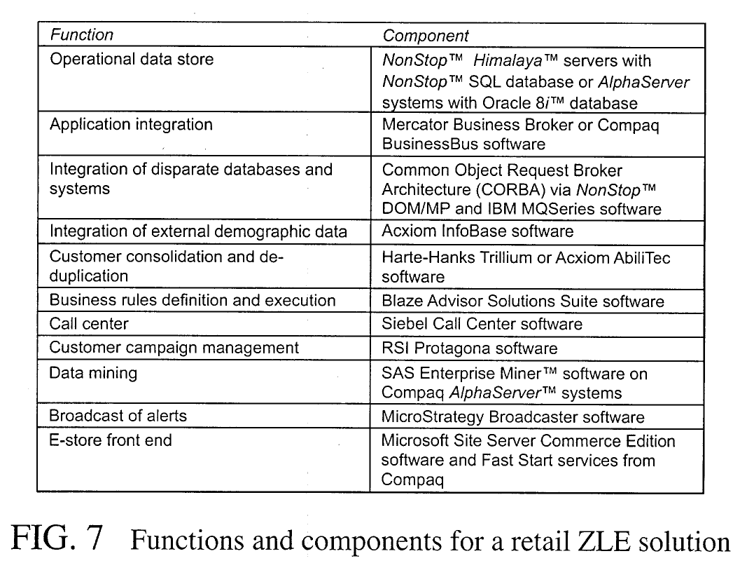

The components of a ZLE retail implementation are assembled, based on customer requirements and preferences, into a retail ZLE solution (see, e.g., FIG. 7). This section examines the components of one ZLE retail implementation.

In this implementation, the ODS and EAI components are implemented with a server such as the NonStop™ server with the NonStop™ SQL database or the AlphaServer system with Oracle 8i™ (ODS), along with Mercator's Business Broker or Compaq's BusinessBus. Additional integration is achieved through the use of CORBA technology and IBM's MQSeries software.

For integration of data such as external demographics, the Acxiom's InfoBase software is utilized to enrich internal customer information with the demographics. Consolidation and de-duplication of customer data is achieved via either Harte-Hanks's Trillium or Acxiom's AbiliTec software.

The interaction manager (IM) uses the Blaze Advisor Solutions Suite software, which includes a Java-based rules engine, for the definition and execution of business rules. The IM suggests appropriate responses to e-store visitor clicks, calls to the call center, point-of-sale purchases, refunds, and a variety of other interactions across a retail enterprise.

Data mining analysis is performed via SAS® Enterprise Miner™ running on a server such as the Compaq AlphaServer™ system. Source data for mining analysis is extracted from the ODS and moved to the mining platform. The results of any mining analysis, such as predictive models, are deployed into the ODS and used by the rules engine or directly by the ZLE applications. The ability to mix patterns discovered by sophisticated mining analyses with business rules and policies contributes to a very powerful and useful IM.

There are lots of potential applications of data mining in a ZLE retail environment. These include: e-store cross-sell and up-sell; real-time fraud detection, both in physical stores and e-stores; campaign management; and making personalized offers at all touch-points. In the next section, we will examine real-time fraud detection.

C. Implementation Example—A ZLE Solution for Risk Detection

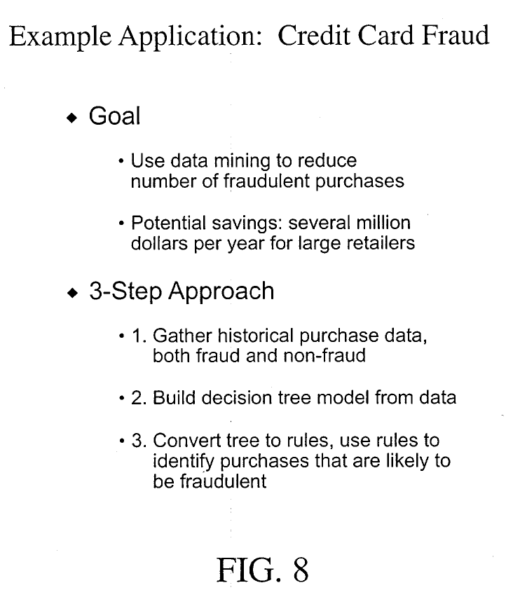

This example pertains to the challenge of how to apply data mining technology to the problem of detecting fraud. FIGS. 8-12 illustrate an approach taken in using data mining technology for fraud detection in a retail environment. In this example we can likewise assume a ZLE framework architecture for a retail solution as described above. In this environment, ZLE Analytic learning cycles with data mining techniques provide a fraud detection opportunity when company issued credit cards are misused—fraud which otherwise would go undetected at the time of infraction. A strong business case exists for adding ZLE analytic learning cycle technology to a retailer's asset protection program (FIG. 8). For large retail operations, reducing credit card fraud translates to potential saving of millions of dollars per year even though typical retail credit card fraud rates are relatively small—on the order of 0.25 to 2%.

It is assumed that more contemporary retailers use some type of empirically-driven rules or predictive mining models as part of their asset protection program. In their existing environments, predictions are probably made based on a very narrow customer view. The advantage a ZLE framework provides is that models trained on current and comprehensive customer information can utilize up-to-the-second information to make real-time predictions.

For example, in study case described here we consider credit cards that are owned by the retailer (e.g., department store credit cards), not cards produced by a third party or bank. The card itself is branded with the retailer's name. Although it is possible to obtain customer data in other settings, in this case, the retailer has payment history and purchase history information for the consumer. As further shown in FIG. 8, the 3-step approach uses the historical purchase data to next build a decision tree, convert it to rules, and use the rules to identify possible fraudulent purchases.

1. Source Data for Fraud Detection

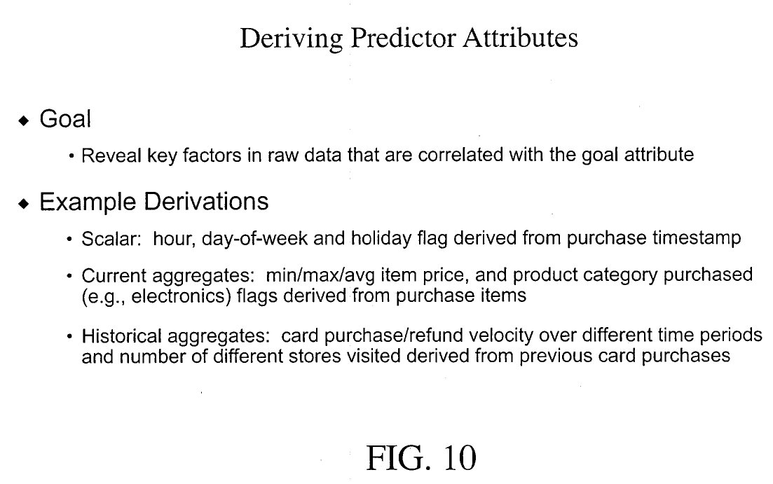

As discussed above, all source data is contained in the ODS. As such, much of the data preparation phase of standard data mining has already been accomplished. The integrated, cleaned, de-duplicated, demographically enriched data is ready to mine. A successful analytic learning cycle for fraud detection requires the creation of a modeling data set with carefully chosen variables and derived variables for data mining. The modeling data set is also referred to as a case set. Note that we use the term variable to mean the same as attribute, column, or field. FIG. 9 shows historical purchase data in the form of modeling data case sets each describing the status of a credit card account. There is one row in the modeling data set per purchase. Each row can be thought of as a case, and as indicated in FIG. 10 the goal of the data mining exercise is to find patterns that differentiate the fraud and non-fraud cases. To that end, one target is to reveal key factors in the raw data that are correlated with the variables (or attributes).

Credit card fraud rates are typically in the range of about 0.25% to 2%. For model building, it is important to boost the percentage of fraud in the case set to the point where the ratio of fraud to non-fraud cases is higher, to as much as 50%. The reason for this is that if there are relatively few cases of fraud in the model training data set, the model building algorithms will have difficulty finding fraud patterns in the data.

Consider the following demonstration of a study related to eCRM in the ZLE environment. The model data set used in the eCRM ZLE study-demonstration contains approximately 1 million sample records, with each record describing the purchase activity of a customer on a company credit card. For the purposes of this paper, each row in the case set represents aggregate customer account activity over some reasonable time period such that it makes sense for this account to be classified as fraudulent or non-fraudulent (e.g., FIG. 9). This was done out of convenience due to a customer-centric view for demonstration purposes of the ZLE environment. Real world case sets would more typically have one row per transaction, each row being identified as a fraudulent or non-fraudulent transaction. The number of fraud cases, or records, is approximately 125K, which translates to a fraudulent account rate of about 0.3% (125K out of the 40M guests in the complete eCRM study database). Note how low this rate is, much less than 1%. All 125K fraud cases (i.e., customers for which credit-card fraud occurred) are in the case set, along with a sample of approximately 875K non-fraud cases. Both the true fraud rate (0.3%) and the ratio of non-fraud to fraud cases (roughly 7 to 1) in the case set are typical of what is found in real fraud detection studies. The data set for this study is a synthetic one, in which we planted several patterns (described in detail below) associated with fraudulent credit card purchases.

We account for the difference between the true population fraud rate of 0.3% and the sample fraud rate of 12.5% by using the prior probability feature of Enterprise Miner™ a feature expressly designed for this purpose. Enterprise Miner™ (EM) allows the user to set the true population probability of the rare target event. Then, EM automatically takes this into consideration in all model assessment calculations. This is discussed in more detail below in the model deployment section of the paper. The study case set contained the following fields:

RAC30: number of cards reissued in the last 30 days.

TSPUR7: total number of store purchases in the last 7 days.

TSRFN3: total number of store refunds in the last 3 days.

TSRFNV 1: total number of different stores visited for refunds in the last 1 day.

TSPUR3: total number of store purchases in the last 3 days.

NSPD83: normalized measure of store purchases in department 8 (electronics) over the last 3 days. This variable is normalized in the sense that it is the number of purchases in department 8 in the last 3 days, divided by the number of purchases in the same department over the last 60 days.

TSAMT7: total dollar amount spent in stores in the last 7 days.

FRAUDFLAG: target variable.

The first seven are independent variables (i.e., the information that will be used to make a fraud prediction) and the eighth is the dependent or target variable (i.e., the outcome being predicted).

Note that building the case set requires access to current data that includes detailed, transaction-level data (e.g., to determine NSPD83) and data from multiple customer touch-points (RAC30 which would normally be stored in a credit card system, and variables such as TSPUR7 that describe in-store POS activity which would be stored in a different system). As pointed out before, the task of building an up-to-date modeling data set from multiple systems is facilitated greatly in a ZLE environment through the ODS.

Further note that RAC30, TSPUR7, TSRFN3, TSRFNV1, TSPUR3, NSPD83, and TSAMT7 are “derived” variables. The ODS does not carry this information in exactly this form. These records were created by calculation from other existing fields. To that end, an appropriate set of SQL queries is one way to create the case set.

2. Credit Card Fraud Methods

According to ongoing studies it is apparent that one type of credit card fraud begins by stealing a newly issued credit card. For example, a store may send out a new card to a customer and a thief may steal it out of the customer's mailbox. Thus, the data set contains a variable that describes whether or not cards have been reissued recently (RAC30).

Evidently, thieves tend to use stolen credit cards frequently over a short period of time after they illegally obtained the cards. For example, a stolen credit card is used within 1-7 days, before the stolen card is reported and stops being accepted. Thus, the data set contains variables that describe the total number of store purchases over the last 3 and 7 days, and the total amount spent in the last 7 days. Credit card thieves also tend to buy small expensive things, such as consumer electronics. These items are evidently desirable for personal use by the thief or because they are easy to sell “on the street”. Thus, the variable NSPD83 is a measure of the history of electronics purchases. Finally, thieves sometimes return merchandise bought with a stolen credit card for a cash refund. One technique for doing this is to use a fraudulent check to get a positive balance on a credit card, and then items are bought and returned. Because there is a positive balance on the card used to purchase the goods, cash refund may be issued (the advisability of refunding cash for something bought on a credit card is not addressed here). Thieves often return merchandise at different stores in the same city, to lower the chance of being caught. Accordingly, the data set contains several measures of refund activity.

To summarize, the purchase patterns associated with a stolen credit card involve multiple purchases over a short period of time, high total dollar amount, cards recently reissued, purchases of electronics, suspicious refund activity, and so on. These are some of the patterns that the models built in the study-demonstration are meant to detect.

3. Analytic Learning Cycle with Modeling

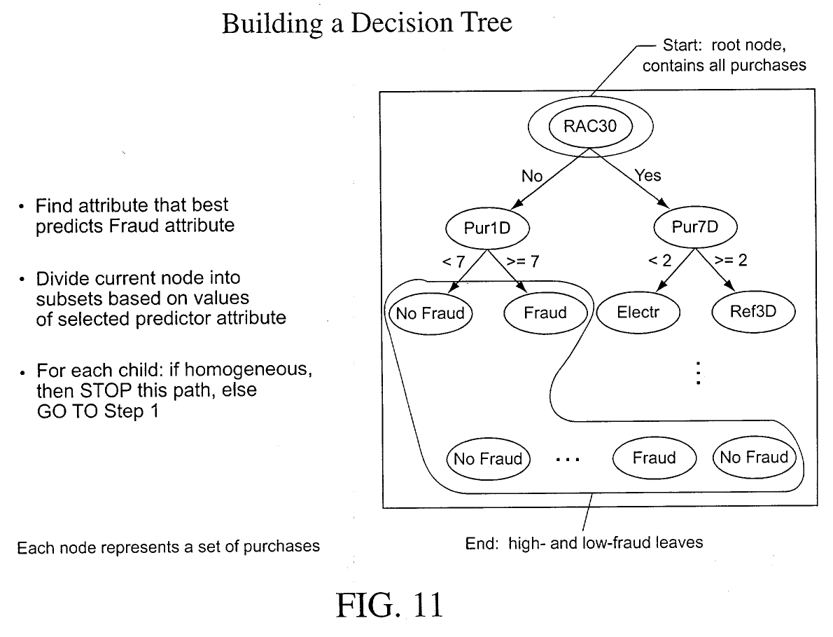

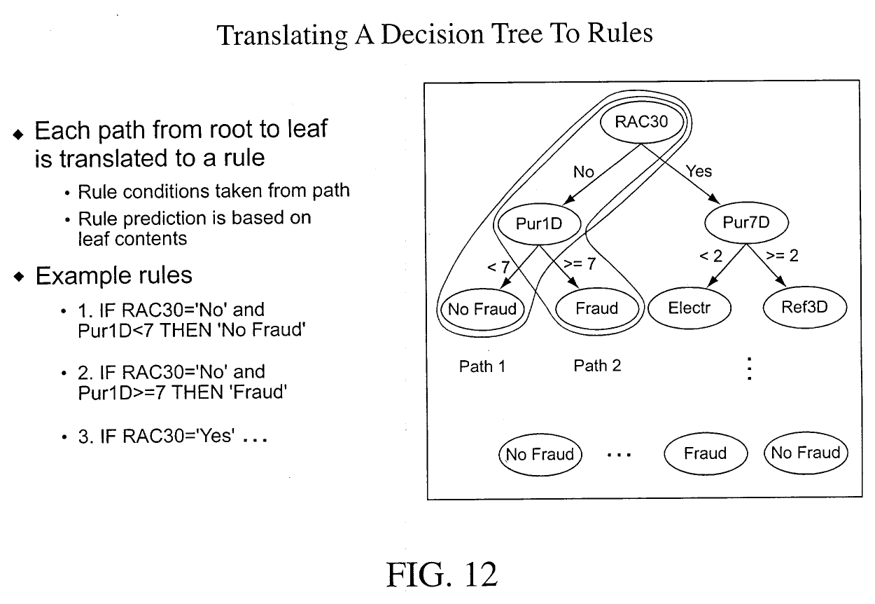

SAS® Enterprise Miner™ supports a visual programming model, where nodes, which represent various processing steps, are connected together into process flows. The study-demonstration process flow diagram contains the nodes as previously shown for example in FIG. 5. The goal here is to build a model that predicts credit card fraud. The Enterprise Miner™ interface allows for quick model creation, and easy comparison of model performance. As previously mentioned FIG. 6 shows an example of a decision tree model, while FIG. 11 illustrates building the decision tree model and FIG. 12 illustrates translating the decision tree to rules.

As respectively shown in FIGS. 11 and 12. The various paths through the tree, and the IFTHEN rules associated with them, describe the fraud patterns associated with credit card fraud. One interesting path through the tree sets a rule as follows:

If cards reissued in last 30 days, and

total store purchases over last 7 days>1, and

number of different stores visited for refunds in current day>1, and

normalized number of purchases in electronics dept. over last 3 days>2, then probability of fraud is HIGH.

As described above, the conditions in this rule identify some of the telltale signs of credit card fraud, resulting in a prediction of fraud with high probability. The leaf node corresponding to this tree has a high concentration of fraud (approximately 80% fraud cases, 20% non-fraud) in the training and validation sets. (The first column of numbers shown on this and other nodes in the tree describes the training set, and the second column the validation set.) Note that the “no fraud” leaf nodes contain relatively little or no fraud, and the “fraud” leaf nodes contain relatively large amounts of fraud.

A somewhat different path through the tree sets a rule as follows:

If cards reissued in last 30 days, and

total store purchases in last 7 days>1, and

number of different stores visited for refunds in current day>1, and

normalized number of purchases in electronics dept. in last 3 days<=2, and

total amount of store purchases in last 7 days>=700,

then probability of fraud is HIGH

This path sets a rule similar to the previous rule except that fewer electronics items are purchased, but the total dollar amount purchased in the last 7 days is relatively large (at least $700).

An alternative data mining model, produced with a neural network node in Enterprise Miner™, gives comparable results. In fact, the relative performance of these two classic data mining tools was very similar—even though the approaches are completely different. It is possible that tweaking the parameters of the neural network model might have given a more powerful tool for fraud prediction, but this was not done during this study.

Understanding exactly how a model is making its predictions is often important to business users. In addition, there are potential legal issues—it may be that a retailer cannot deny service to a customer without clear English explanation—something that is not possible with a neural network model. Neural network models use complex functions of the input variables to estimate the fraud probability. Hence, relative to neural networks, prediction logic in the form of IF-THEN rules in the decision-tree model is easier to understand.

a. Model Tables

### (1) Models Data Table

Id (integer)—unique model identifier.

Name (varchar)—model name.

Description (varchar)—model description.

Version (char)—model version.

DeployDate (timestamp)—the time a model was added to the Models table.

Type (char)—model type: TREE RULE SET, TREE, NEURAL NETWORK, REGRESSION, or CLUSTER, ENSEMBLE, PRINCOMP/DMNEURAL, MEMORY-BASED REASONING, TWO STAGE MODEL.

AsJava (smallint)—boolean, non-zero if deployed as SAS Jscore.

AsPMML (smallint)—boolean, non-zero if deployed as PMML.

SASEMVersion (char)—version of EM in which model was produced.

EMReport (varchar)—name of report from which model was deployed.

SrcSystem (varchar)—the source mining system that produced the model (e.g., SASO Enterprise Miner™).

SrcServer (varchar)—the source server on which the model resides.

SrcRepository (varchar)—the id of the repository in which the model resides.

SrcModelName (varchar)—the source model name.

SrcModelld (varchar)—the source model identifier, unique within a repository.

This table contains one row for each version of a deployed model. The Id, Name and Version fields are guaranteed to be unique, and thus provide an alternate key field. The numeric Id field is used for efficient and easy linking of model information across tables. But for users, an id won't be meaningful, so name and version should be used instead.

New versions of the same model receive a new Id. The Name field may be used to find all versions of a particular model. Note that the decision to assign a new Id to a new model version means that adding a new version requires adding new rules, variables, and anything else that references a model, even if most of the old rules, variables and the like remain unchanged. The issue of which version of a model to use is typically a decision made by an application designer or mining analyst.

AsJava and AsPMML are boolean fields indicating if this model is embodied by Jscore code or PMML text in the ModJava or ModPMML tables, respectively. A True field value means that necessary Fragment records for this ModelId are present in the ModJava or ModPMML tables. Note that it is possible for both Jscore and PMML to be present. In that case, the scoring engine determines which deployment method to use to create models. For example, it may default to always use the PMML version, if present.

The fields beginning with the prefix ‘Src’ record the link from a deployed model back to its source. In one implementation, the only model source is SAS® Enterprise Miner™, so the various fields (SrcServer, SrcRepository, etc.) store the information needed to uniquely identify models in SAS® Enterprise Miner™.

### (2) Model PMML Table

ModelPMML table is structured as follows:

ModelId (integer)—identifies the model that a PMML document describes.

SequenceNum (integer)—sequence number of a PMML fragment.

PMMLFragment (varchar)—the actual PMML description.

This table contains the PMML description for a model. The ‘key’ fields are: ModelId and SequenceNum. An entire PMML model description may not fit in a single row in this table, so the structure of the table allows a description to be broken up into fragments, and each fragment to be stored in a separate row. The sequence number field records the order of these fragments, so the entire PMML description can be reconstructed.

Incidentally, PMML (predictive model markup language) is an XML-based language that enables the definition and sharing of predictive models between applications (XML stand for extensible markup language). As indicated, a predictive model is a statistical model that is designed to predict the likelihood of target occurrences given established variables or factors. Increasingly, predictive models are being used in e-business applications, such as customer relationship management (CRM) systems, to forecast business-related phenomena, such as customer behavior. The PMML specifications establish a vendor-independent means of defining these models so that problems with proprietary applications and compatibility issues can be circumvented.

Sequence numbers start at 0. For example, a PMML description for a model that is 10,000 long could be stored in three rows, the first one with a sequence number of 0, the second 1, and the third 2. Approximately the first 4000 bytes of the PMML description would be stored in the first row, the next 4000 bytes in the second row, and the last 2000 bytes in the third row. In this implementation, the size of the PMMLFragment field, which defines how much data can be stored in each row, is constrained by the 4 KB maximum page size supported by NonStop SQL.

### (3) Rule Variables

The input and output variables for a set of model rules are described in the RuleVariables table.

Modelld (integer)—identifies the model to which a variable belongs.

Name (varchar)—variable name.

Direction (char)—IN or OUT, indicating whether a variable is used for input or output.

Type (char)—variable type (“N” for numeric or “C” for character).

Description (varchar)—variable description.

StructureName (varchar)—name of Java structure containing variable input data used for scoring.

ElementName (varchar)—name of element in Java structure containing input scoring data.

FunctionName (varchar)—name of function used to compute variable input value.

ConditionName (varchar)—name of condition (Boolean element or custom function) for selecting structure instances to use when computing input variable values.

This table contains one row per model variable. The ‘key’ fields are: ModelId and Name. By convention, all IN variables come before OUT variables.

Variables can be either input or output, but not both. The Direction field describes this aspect of a variable.

4. Model Assessment

The best way to assess the value of data mining models is a profit matrix, a variant of a “confusion matrix” which details the expected benefit of using the model, as broken down by the types of prediction errors that can be made. The classic confusion matrix is a simple 2×2 matrix assessing the performance of the data mining model by examining the frequency of classification successes/errors. In other words, the confusion matrix is a way for assessing the accuracy of a model based on an assessment of predicted values against actual values.

Ideally, this assessment is done with a holdout test data set, one that has not been used or looked at in any way during the model creation phase. The data mining model calculates an estimate of the probability that the target variable, fraud in our case, is true. When using a decision tree model, all of the samples in a given decision node of the resulting tree have the same predicted probability of fraud associated with them. When using the neural network model, each sample may have its own unique probability estimate. A business decision is then made to determine a cutoff probability. Samples with a probability higher than the cutoff are predicted fraudulent, and samples below the cutoff are predicted as non-fraudulent.

Since we over-sampled the data, there are actually two probabilities involved: the prior probability and the subsequent probability of fraud. The prior represents the true proportion of fraud cases in the total population—a number often less than 1%. The subsequent probability represents the proportion of fraud in the over-sampled case set—as much as 50%. After setting up Enterprise Miner™'s prior probability of fraud for the target variable to reflect the true population probability, Enterprise Miner™ adjusts all output tables, trees, charts, graphs, etc. to show results as though no oversampling had occurred—scaling all output probabilities and counts to reflect how they would appear in the actual (prior) population. Enterprise Miner™'s ability to specify the prior probability of the target variable is a very beneficial feature for the user.

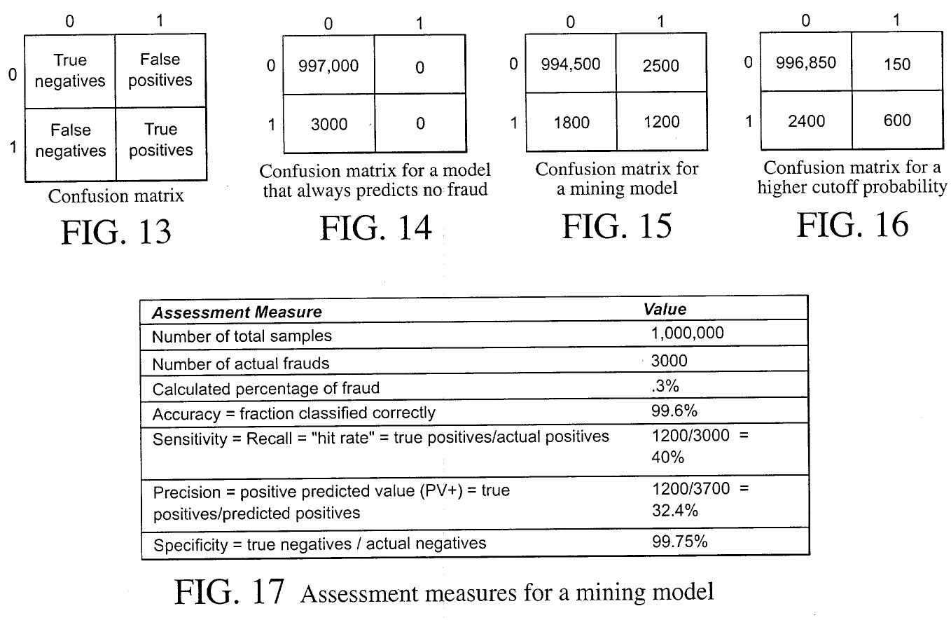

For easy reference, FIGS. 13-16 provide confusion matrix examples. FIG. 13 shows, in general, a confusion matrix. The ‘0’ value indicates in this case ‘no fraud’ and the ‘1’ value indicates ‘fraud’. The entries in the cells are usually counts. Ratios of various counts and/or sums of counts are often calculated to compute various figures of merit for the performance of the prediction/classification algorithm. Consider a very simple algorithm, requiring no data mining—i.e., that of simply deciding that all cases are not fraudulent. This represents a baseline model with which to compare our data mining models. FIG. 14 shows the resulting confusion matrix for a model that always predicts no fraud, and for that reason the fraud prediction (i.e., number of fraud occurrences) in the second column equals 0. This extremely simple algorithm would be correct 99.7% of the time. But no fraud would ever be detected. It has a hit rate of 0%. To improve on this result, we must predict some fraud. Inevitably, doing so will increase the false positives as well.

FIG. 15 shows a confusion matrix, for some assumed cutoff, showing sample counts for holdout test data. The choice of cutoff is a very important business decision. In reviewing the results of this study for the retailer implementation, it became extraordinarily clear that this decision as to where to place the cutoff makes all the difference between a profitable and not so profitable asset protection program.

Let's examine the example confusion matrix presented above in more detail. FIG. 17 is a statistics summary table (note that positives=frauds). Remarkably, even though the accuracy of the model is extremely good—the model classifies 99.6% of holdout case set samples correctly the Recall and Precision are not nearly as good, 40% and 32% respectively. This is a common situation when data mining for fraud detection or any other low probability event situation.

As a business decision, the retailer can decide to alter the probability threshold (cutoff) in the model—i.e., the point at which a sample is considered fraudulent vs. not fraudulent. Using the very same decision tree or neural network, a different confusion matrix results. For example, if the cutoff probability is increased, there will be fewer hits (fewer frauds will be predicted during customer interactions). FIG. 16 illustrates the confusion matrix with a higher cutoff probability. The hit rate, or sensitivity, is 600/3000=20%, half as good as the previous cutoff. However, the precision has improved from 32% to 80%. Fewer false positives, means fewer customers getting angry because they've falsely been accused of fraudulent behavior. The expense of this benefit comes in the form of less fraud being caught.

To make a proper determination about where to place the cutoff, the retailer needs to compare costs involved with turning away good customers to margin lost on goods stolen through genuine credit card fraud. A significant issue is determining the best way to deploy the fraud prediction. Since the ZLE solution makes a determination of fraud immediately at the time of the transaction, if the data mining model predicts a given transaction is with a fraudulent card, various incentives to disallow the transaction can be initiated—without necessarily an outright denial. In other words, measures need to be taken which discourage further fraudulent use of the card, but which will not otherwise be considered harmful to the customer who is not committing any fraud whatsoever. Examples of this might be asking to see another form of identification, (if the credit card is being used in a brick and mortar venue), or asking for further reference information from the customer if it is an e-store transaction.

5. Model Deployment

Once a model is built, the model is stored in tables at the ODS and the model output is converted to rules. Those rules are entered into the ZLE rules engine (rules service). These rules are mixed with other kinds of rules, such as policies. Note that decision tree results are already in essential rule form—IF-THEN statements that functionally represent the structure of the leaves and nodes of the tree. Neural network output can also be placed in the rules engine by creating a calculation rule which applies the neural network to the requisite variables for generating a fraud/no fraud prediction. For example, Java code performing the necessary calculations on the input variables could be generated by Enterprise Miner™.

6. Model Execution and Subsequent Learning Cycles

As previously shown in FIGS. 4a & 4b, the scoring engine reads the models from the ODS and applies the models to input variables. The results from the scoring engine in combination with the results from the rules engine are used, for example, by the interaction manager to provide personalized responses to customers. Such responses are maintained as historical data at the ODS. Then, subsequent interactions and additional data can be retrieved and analyzed in combination with the historical data to refresh or reformulate the models over and over again during succeeding analytic learning cycles. Each time models are refreshed they are once again deployed into the operational environment of the ZLE framework at the core of which resides the ODS.

To recap, in today's demanding business environment, customers expect current and complete information to be available continuously, and interactions of all kinds to be customized and appropriate. An organization is expected to disseminate new information instantaneously across the enterprise and use it to respond appropriately and in real-time to business events. Preferably, therefore, analytical learning cycle techniques operate in the context of the ZLE environment. Namely, the analytical learning cycle techniques are implemented as part of the scheme for reducing latencies in enterprise operations and for providing better leverage of knowledge acquired from data emanating throughout the enterprise. This scheme enables the enterprise to integrate its services, business rules, business processes, applications and data in real time. Having said that, although the present invention has been described in accordance with the embodiments shown, variations to the embodiments would be apparent to those skilled in the art and those variations would be within the scope and spirit of the present invention. Accordingly, it is intended that the specification and embodiments shown be considered as exemplary only, with a true scope of the invention being indicated by the following claims and equivalents.

What is claimed is:

1. A method for knowledge discovery through analytic learning cycles, comprising:
defining a problem associated with an enterprise;
executing a cycle of analytic learning which is founded on a view of data from across the enterprise, the data having been captured and aggregated and is available at a central repository, the analytic learning cycle employs data mining including
exploring the data at the central repository in relation to the problem,
preparing a modeling data set from the explored data,
building a model from the modeling data set,
assessing the model,
deploying the model back to the central repository, and
applying the model to a set of inputs associated with the problem to produce results, thereby creating historic data that is saved at the central repository; and
repeating the cycle of analytic learning using the historic as well as current data accumulated in the central repository, thereby creating up-to-date knowledge for evaluating and refreshing the model.

2. The method of claim 1, wherein the enterprise experiences a plurality of events occurring at a plurality of sites across the enterprise in association with its operations, wherein a plurality of applications are run in conjunction with these operations, wherein the operations, the plurality of events and applications, and the data are integrated so as to achieve the view as a coherent, real-time view of the data from across the enterprise as well as to achieve enterprise-wide coherent and zero latency operations, and wherein the integration is backed by the central repository.

3. The method of claim 1, wherein the data is explored using enterprise-specific predictors related to the problem such that through the analytic learning cycle the data is analyzed in relation to the problem in order to establish patterns in the data.

4. The method of claim 1, wherein a plurality of organizations includes a retail organization, a healthcare organization, a research institute, a financial institution, an insurance company, a manufacturing organization, and a government entity, wherein the enterprise is one of the plurality of organizations, and wherein the problem is defined in relation to operations of the enterprise.

5. The method of claim 1, wherein the problem is defined in the context of asset protection and is formulated for fraud detection.

6. The method of claim 1, wherein the problem is defined in the context of financial transactions with a bank representative or via an ATM (automatic teller machine), the problem being formulated for presenting customer-specific offers in the course of such transactions.

7. The method of claim 1, wherein the problem is defined in the context of business transactions conducted at a point of sale, via a call center, or via a web browser, the problem being formulated for presenting customer-specific offers in the course of such transactions.

8. The method of claim 1, wherein the problem definition creates a statement of the problem and a way of assessing and later evaluating the model, and wherein, based on model assessment and evaluation results, the problem is redefined before the analytic learning cycle is repeated.

9. The method of claim 1, wherein the results are patterns established through the application of the model, wherein the results are logged in the central repository and used for formalizing responses to events, the responses becoming part of the historic data and along with the responses are used in preparing modeling data sets for subsequent analytic earning cycles.

10. The method of claim 1, wherein the data is held at the central repository in the form of tables in relational databases and is explored using database queries.

11. The method of claim 1, wherein the preparation of modeling data set includes transforming explored data to suit the problem and the model.

12. The method of claim 11, wherein the transformation includes reformatting the data to suit the set of inputs.

13. The method of claim 1, wherein the modeling data set holds data in denormalized form.

14. The method of claim 13, wherein the denormalized form is fashioned by taking data in normalized form and lining it up flatly and serially end-to-end in a logically contiguous record so that it is becomes retrievable more quickly relative to normalized data.

15. The method of claim 1, wherein the modeling data set is held at the central repository in a table containing one record per entity.

16. The method of claim 15, wherein the modeling data set is provided to a target file, and wherein the table holding the modeling data set is identified along with the target file and a transfer option.

17. The method of claim 16, wherein the modeling data set is provided to the target file in bulk via multiple concurrent streams, and wherein the transfer option determines the number of concurrent streams.

18. The method of claim 1, wherein the modeling data set is provided from the central repository to a mining server in bulk via multiple concurrent streams.

19. The method of claim 1, wherein based on the assessment of the model one or more of the defining, exploring, preparing, building, and assessing steps are reiterated in order to create another version of the model that more closely represents the problem and provide predictions with better accuracy.

20. The method of claim 1, wherein the data set is prepared using part of the explored data and wherein the model is assessed using a remaining part of the explored data in order to determine whether the model provides predictions with expected accuracy in view of the problem.

21. The method of claim 1, wherein the model is formed with a structure, including one of a decision tree model, a logistic regression model, a neural network model, a nearest neighbor model, a Naïve Bayes model, or a hybrid model.

22. The method of claim 21, wherein the decision tree contains a plurality of nodes in each of which there being a test corresponding to a rule that leads to decision values corresponding to the results of the test.

23. The method as in claim 21, wherein the neural network includes input and output layers and any number of hidden layers.

24. The method as in claim 1, wherein the defining, exploring, preparing, building, and assessing steps are used to build a plurality of models that upon being deployed are placed in a table at the central repository and are differentiated from one another by their respective identification information.

25. The method as in claim 1, wherein the model is applied to the set of inputs in response to a prompt from an application to which the results or information associated with the results are returned.

26. A system for knowledge discovery through analytic learning cycles, comprising:
a central repository;
means for providing a definition of a problem associated with an enterprise;
means for executing a cycle of analytic learning which is founded on a view of data from across the enterprise, the data having been captured and aggregated and is available at the central repository, the analytic learning cycle execution means employs data mining means including
means for exploring the data at the central repository in relation to the problem,
means for preparing a modeling data set from the explored data,
means for building a model from the modeling data set,
means for assessing the model,
means for deploying the model back to the central repository, and
means for applying the model to a set of inputs associated with the problem to produce results, thereby creating historic data that is saved at the central repository; and
means for repeating the cycle of analytic learning using the historic as well as current data accumulated in the central repository, thereby creating up-to-date knowledge for evaluating and refreshing the model.

27. The system of claim 26, further comprising:
a plurality of applications, wherein the enterprise experiences a plurality of events occurring at a plurality of sites across the enterprise in association with its operations, wherein the plurality of applications are run in conjunction with these operations; and
means for integrating the operations, the plurality of events and applications, and the data so as to achieve the view as a coherent, real-time view of the data from across the enterprise as well as to achieve enterprise-wide coherent and zero latency operations, and wherein the integration means is backed by the central repository.

28. The system of claim 26, wherein the data is explored using enterprise-specific predictors related to the problem such that through the analytic learning cycle the data is analyzed in relation to the problem in order to establish patterns in the data.

29. The system of claim 26, wherein a plurality of organizations includes a retail organization, a healthcare organization, a research institute, a financial institution, an insurance company, a manufacturing organization, and a government entity, wherein the enterprise is one of the plurality of organizations, and wherein the problem is defined in relation to operations of the enterprise.

30. The system of claim 26, wherein the problem is defined in the context of asset protection and is formulated for fraud detection.

31. The method of claim 26, wherein the problem is defined in the context of financial transactions with a bank representative or via an ATM (automatic teller machine), the problem being formulated for presenting customer-specific offers in the course of such transactions.

32. The method of claim 26, wherein the problem is defined in the context of business transactions conducted at a point of sale, via a call center, or via a web browser, the problem being formulated for presenting customer-specific offers in the course of such transactions.

33. The system of claim 26, wherein the means for providing the problem definition is configured for
creating a statement of the problem as defined for the enterprise and a way of assessing and later evaluating the model, and
providing a modified definition of the problem, if necessary based on model assessment and evaluation results, before the analytic learning cycle is repeated.

34. The system of claim 26, wherein the results are patterns established through the means for applying the model, wherein the results are logged in the central repository and used for formalizing responses to events, the responses becoming part of the historic data and along with the responses are used in preparing modeling data sets for subsequent analytic earning cycles.

35. The system of-claim 26, wherein the central repository is configured to hold the data in the form of tables in relational databases, and wherein the data exploring means is configured to explore the data at the central repository using database queries.

36. The system of claim 26, wherein the modeling data set preparation means includes means for transforming explored data to suit the problem and the model.

37. The system of claim 36, wherein the transforming means is configured for reformatting the data to suit the set of inputs.

38. The system of claim 26, wherein the modeling data set holds data in denormalized form.

39. The system of claim 38, wherein the preparing means is configured for fashioning the denormalized form by taking data in normalized form and lining it up flatly and serially end-to-end in a logically contiguous record so that it is becomes retrievable more quickly relative to normalized data.

40. The system of claim 26, wherein the modeling data set is held at the central repository in a table containing one record per entity.

41. The system of claim 40, further comprising:
means for providing the modeling data set to a target file, the providing means being configured for identifying the table holding the modeling data along with the target file and a transfer option.

42. The system of claim 41, the modeling data set is provided to the target file in bulk via multiple concurrent streams, and wherein the transfer option determines the number of concurrent streams.

43. The system of claim 26, further comprising:
a mining server, wherein the modeling data set is provided from the central repository to the mining server in bulk via multiple concurrent streams.

44. The system of claim 26, wherein, based on an assessment of the model, the system is further configured to prompt one or more of the defining means, exploring means, preparing means, building means, and assessing means to reiterated their operation in order to create another version of the model that more closely represents the problem and provide predictions with better accuracy.

45. The system of claim 26, wherein the data set is prepared using part of the explored data and wherein the model is assessed using a remaining part of the explored data in order to determine whether the model provides predictions with expected accuracy in view of the problem.

46. The system of claim 26, wherein the model is formed with a structure, including one of a decision tree model, a logistic regression model, a neural network model, a nearest neighbor model, a Naïve Bayes model, or a hybrid model.

47. The system of claim 46, wherein the decision tree contains a plurality of nodes in each of which there being a test corresponding to a rule that leads to decision values corresponding to the results of the test.

48. The system as in claim 46, wherein the neural network includes input and output layers and any number of hidden layers.

49. The system as in claim 26, wherein the defining, exploring, preparing, building, and assessing means are used to build a plurality of models that upon being deployed are placed in a table at the central repository and are differentiated from one another by their respective identification information.

50. The system as in claim 26, further comprising:
a plurality of applications, wherein the applying means is configured for applying the model to the set of inputs in response to a prompt from one of the applications to which the results or information associated with the results are returned.

51. A computer readable medium embodying a program for knowledge discovery through analytic learning cycles, comprising:
program code configured to cause a computer to provide a definition of a problem associated with an enterprise;
program code configured to cause a computer system to execute a cycle of analytic learning which is founded on a view of data from across the enterprise, the data having been captured and aggregated and is available at a central repository in real time, wherein the analytic learning cycle employs data mining including
exploring the data at the central repository in relation to the problem,
preparing a modeling data set from the explored data,
building a model from the modeling data set,
assessing the model,
deploying the model back to the central repository, and
applying the model to a set of inputs associated with the problem to produce results, thereby creating historic data that is saved at the central repository; and
program code configured to cause a computer system to repeat the cycle of analytic learning using the historic as well as current data accumulated in the central repository, thereby creating up-to-date knowledge for evaluating and refreshing the model.

52. A system for knowledge discovery through analytic learning cycles, comprising:
a central repository at which the real-time data is available having been aggregated from across the enterprise, the real-time data being associated with events occurring at one or more sites throughout an enterprise;
enterprise applications;
enterprise application interface which is configured for integrating the applications and real-time data and is backed by the central repository so as to provide a coherent, real-time view of enterprise operations and data;
a data mining server configured to participate in an analytic learning cycle by building one or more models from the real-time data in the central repository, wherein the central repository is designed to store such models;
a hub with core services including a scoring engine configured to obtain a model from the central repository and apply the model to a set of inputs from among the real-time data in order to produce results, wherein the central repository is configured for containing the results along with historic and current real-time data for use in subsequent analytic learning cycles.

53. The system of claim 52, wherein the scoring engine has a companion calculation engine configured to calculate scoring engine inputs by aggregating real-time and historic data in real time.

54. The system of claim 52, wherein the central repository contains one or more data sets prepared to suit a problem and a set of inputs from among the real-time data to which a respective model is applied, the problem being defined for finding a pattern in the events and to provide a way of assessing the respective model.

55. The system as in claim 54, wherein, based on results of the respective model assessment, the problem is redefined before an analytic learning cycle is repeated.

56. The system of claim 52, further comprising:
tools for data preparation configured to provide intuitive and graphical interfaces for viewing the structure and contents of the real-time data at the central repository as well as for providing interfaces that specify data transformation.

57. The system of claim 52, further comprising:
tools for data transfer and model deployment configured to provide intuitive and graphical interfaces for viewing the structure and contents of the real-time data at the central repository as well as for providing interfaces that specify transfer options.

58. The system of claim 52, wherein the central repository contains relational databases in which the real-time data is held in normalized form and a space for modeling data sets in which reformatted data is held in denormalized form.

59. The system of claim 52, wherein the central repository is associated with a relational database management system configured to support database queries.

60. The system of claim 52, wherein the central repository contains a table for holding models, each model being associated with an identifier, and one or more of a version number, names and data types of the set of inputs, and a description of model prediction logic formatted as IF-THEN rules.

61. The system of claim 59, wherein the description of model prediction logic consists of JAVA code.
